(19) United States
(12) Patent Application Publication
(10) Pub. No.: US 2005/0289642 A1
(43) Pub. Date: Dec. 29, 2005

(54) Using web services for online permissions

(75) Inventors: Michael A. Pacholec, Sammamish, WA (US); Apurva F. Dalia, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/877,343

(22) Filed: Jun. 25, 2004

(51) Int. Cl. G06F 17/00; G06F 15/16; H04K 1/00; G06F 17/30; H04L 9/00; G06F 7/04; G06F 7/58; G06K 19/00; G06K 9/00; H04L 9/32

(52) U.S. Cl. 726/4; 726/1

(57) ABSTRACT

A method and arrangement for sharing information/data over a network are disclosed. The method and arrangement include authenticating a user by way of an authentication process. The authenticated user may share his/her information with another authenticated user over a network. The method may be embodied as an application program interface (API) to allow use of the method with various operating systems, the Internet and/or application programs.

### FIELD OF THE INVENTION

The present invention generally relates to information sharing. More particularly, the present invention generally relates to the sharing of information over a network with users having a required level of permissions and/or access.

### BACKGROUND OF THE INVENTION

There are many types of data that users need to manage and otherwise access. For example, users store and access word processing documents, spreadsheet documents, calendars, telephone numbers, addresses, email messages, financial information, and so on. Other stored information may also include phone numbers, email address, and digital photography. In general, users maintain this information on various personal computers, hand-held computers, pocket-size computers, personal digital assistants, mobile phones and other electronic devices. In most cases, the user-maintained information is stored directly on the respective device. Alternatively, a device may store user information on a storage device that is accessible via a network. Whether the user information is stored directly on a user's device, and/or a network managed storage facility, the user generally must have proper access to the device and/or network in order to retrieve the stored information.

Currently, many corporate networks, and the like, provide users with remote access to some of their data stored on various computing devices. This allows authorized users relatively easy access to data stored on local devices and/or network associated storage devices.

In many instances, it may be desirable to allow users to share various data stored on computing devices and/or corporate network associated storage devices. Although many operating interfaces and computer devices allow users to share authorized accessible information, this sharing facility is generally confined to computers networked in a corporate environment. Moreover, this sharing capability is generally confined to computer programs that are developed using the same programming language.

Therefore, there remains a need for allowing for the sharing of information over a widely dispersed network environment, such as the Internet, that may utilize diverse operating systems and/or computer programs.

The use of application program interfaces (APIs) is prevalent with computer programmers. An API is a tool for a programmer who wishes to create new programs (or applications) that will integrate with many different software platforms. In particular, an API works as an interface between the application program, the operating system, and the CPU/hardware. Therefore, once an API is developed by a programmer, an application utilizing the developed API may run on different CPUs and/or operating systems.

APIs also can be used in the Internet environment. For example, APIs can be used to provide web services to users of the Internet. Using APIs to offer web services allows service providers on the World Wide Web (WWW) to tailor the graphical interface viewed by the users. For example, one service provider may use an API to support a graphical interface designed to sell sports related goods, where another service provider may use the same API to support a graphical interface designed to sell exclusively clothing related goods. Thus, a well designed API may be very useful to a diverse service provider group.

### SUMMARY OF THE INVENTION

An exemplary embodiment of the present invention provides a method that allows a user to share information over a network using one or more APIs. In particular, one exemplary embodiment of the present invention allows a Microsoft® .NET Passport authenticated user to share information with another Microsoft® .NET Passport authenticated user.

Another exemplary embodiment of the present invention provides a method of processing a received service selection; and identifying a role and an entity associated with the service selection.

Yet another exemplary embodiment of the present invention provides a computer readable media and/or a computer system embodying a method according to an exemplary embodiment of the present invention.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an exemplary client server networked environment for use with the exemplary embodiments of the present invention;

FIG. 2 illustrates an exemplary client device suitable for use with the exemplary embodiments of the present invention and the networked system 100 illustrated in FIG. 1;

FIG. 3 is a flow diagram illustrating an exemplary method in accordance with an exemplary embodiment of the present invention;

FIG. 4 illustrates a method of sharing a calendar using an exemplary embodiment of the present invention; and

FIG. 5 illustrates a method by which an authorized user, having a particular assigned role, accesses a calendar, according to an exemplary embodiment of the present invention.

### DETAILED DESCRIPTION OF EXEMPLARY EMBODIMENTS

In accordance with the exemplary embodiments of the present invention, various client devices may be interfaced with one or more servers via the Internet, or other similar network environment. In accordance with the aspects of the exemplary embodiments of the present invention, various client devices and servers may communicate regardless of processor class or family, the type and the version of operating system used, the display resolution capability, the installed software components, the peripheral devices connected to the client computers and servers, and/or the like.

The sharing of information between various client devices may be accomplished through the use of one or more application program interfaces (APIs) function calls, and the system/component registry of the various operating systems utilized on the client devices. One exemplary embodiment of such an API is described in the attached appendix. However, those of ordinary art will appreciate the attached API description is provide by way of example only, and that other programming interfaces may also be used with the exemplary embodiments of the present invention.

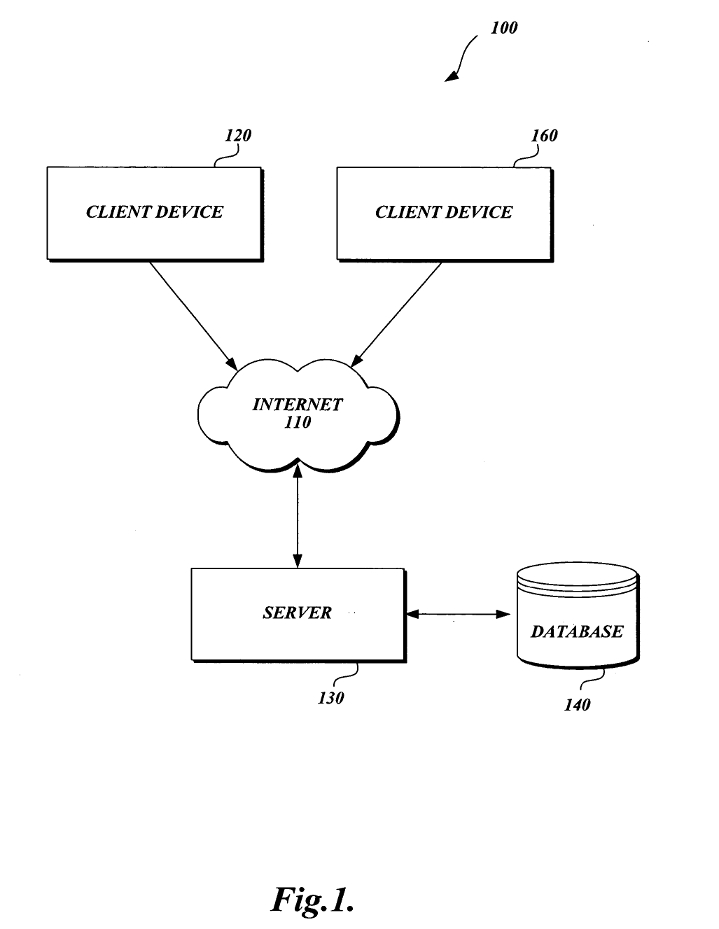

FIG. 1 illustrates an exemplary client server networked environment for use with the exemplary embodiments of the present invention. As is shown, a networked system 100 is networked via the Internet 110. However, the use of the Internet 110 with the networked system 100 is illustrated by way of example only. For example, the Internet 110 may be replaced with, inter alia, a local area network (LAN), or another wide area network (WAN).

The Internet 110 may include the use of the World Wide Web (WWW), which may include a plurality of computers, routers, gateways and/or portions of the public switched telephone network (PSTN), as is readily understood to those familiar with the architecture of the Internet.

The networked system 110 may include the use of various client devices 120 and 160. It should be understood that various types of client devices 120 and 160 may be used with the network system 100. Moreover, the client devices 120 and 160 may include the use of an interface, such as a Web browser or other such graphical user interface (GUI).

The networked system 110 also includes a server 130. For simplicity, only one server 130 is shown; however, it should be understood that there may be a number of servers offering various products and services to the client devices 120 and 160. The server 130 provides an interface, e.g., one or more Web pages and/or applications viewable and accessible by the client devices 120 through the Internet 110, using a Web browser installed on the client devices 120 and 160. The interface may be, e.g., hypertext markup language (HTML) pages, dynamic hypertext markup language (DHTML) pages, active server pages (ASP), or the like.

The server 130 is interfaced with a database 140. The database 140 may have stored therein, inter alia, information related to the client devices 120 and 160. Moreover, the database 140 may also include information pertinent to the operation of the server 130. Further discussion of data/information stored in the database 140 will be discussed in conjunction with the exemplary embodiments of the present invention.

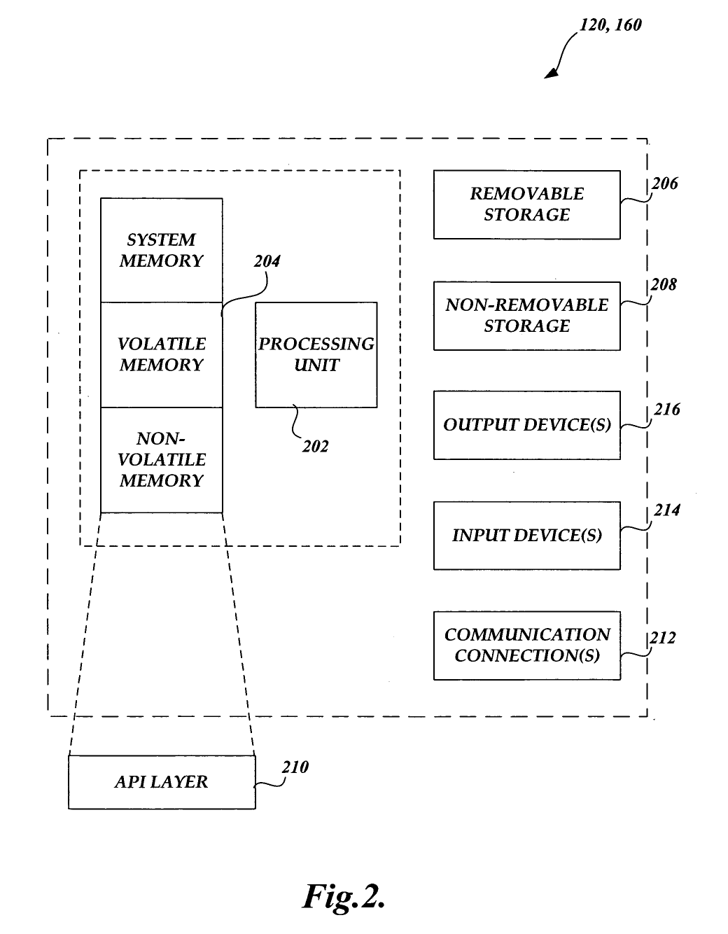

FIG. 2 illustrates an exemplary client device (120 or 160) suitable for use with the exemplary embodiments of the present invention and the networked system 110 illustrated in FIG. 1. The following description will make reference to the client device 120 only; however, the description of the client device 120 also applies to the client device 160.

In its most basic form, the client device 120 includes at least one processing unit 202 and a memory 204. Depending on the configuration of the client device 120, the memory 204 may include the use of a volatile memory (such as RAM), non-volatile memory (such as ROM, flash memory, etc.), or a combination of the two.

The client device 120 may also have additional features and/or functionality. For example, the client device 120 may also include additional storage, removable and/or non-removable including, but not limited to, magnetic, optical disks or tape. Such additional storage is illustrated in FIG. 2 as a removable storage 206 and a non-removable storage 208. In general, computer storage media includes volatile and non-volatile, removable and non-removable media implemented using any method or technology for storage of computing information (e.g., computer-readable instructions, data structures, program modules, or other such data, etc.). The memory 204, the removable storage 206, and the non-removable storage 208 are all examples of computer storage media. Computer storage media includes, but is not limited to, RAM, ROM, EEPROM, flash memory, or other memory technology, CD, DVD, or other optical storage, magnetic cassettes, magnetic tape, magnetic disk storage, or other magnetic storage devices, or any other media which can be used to store or read desired information and that can be accessed by the client device 120. The memory 204 of the client device 120 practicing an exemplary embodiment of the present invention stores an API layer 210 that includes at least one API for implementing at least one exemplary embodiment of the present invention.

The client device 120 also includes a communication connection 212 that allows the device to communicate with other devices via the Internet 110. The communication connection 212 is used to communicate computer-readable instructions, data structures, program modules, and/or other data using a modulated data signal that includes a carrier wave or other transport mechanism modulated of the data to be communicated. The communication connection 212 may be facilitated by way of wired connections, both copper and optical, and wireless connections such as acoustic, radio frequency, infrared, etc.

The client device 120 may also include various input devices 214. These input devices 214 may include a keyboard, a mouse, a pen, a voice input device, a touch input device, etc. Moreover, the server device 120 may also include output devices 216, such as a display, speakers, a printer, etc. Further description of these devices is not required, as such is known to those having ordinary skill in the art.

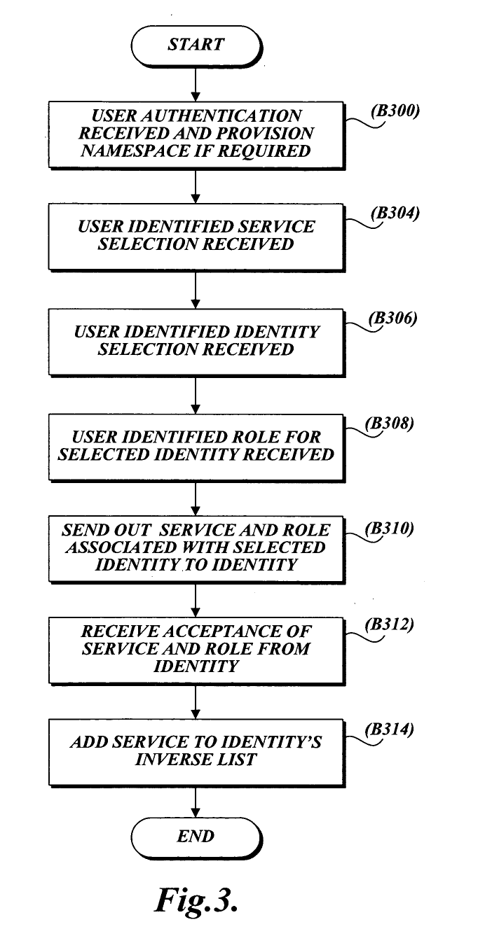

FIG. 3 is a flow diagram illustrating an exemplary method in accordance with an exemplary embodiment of the present invention. The illustrated method may be embodied as an API, or programmed as an executable script in a desired computer readable language.

As illustrated, a user's authentication is received by the server 130 via the client device 120 (B300). In general, the user's authentication received by the server 130 via the client device 120 authorizes a user of the client device 120 to access information and data associated with the authorized user, which may be stored in the database 140. For example, the authorization process may result in the authorized user having access to a subscription service once a successful authorization process is completed. The process may also include provisioning space to store information associated with the authorized user, in the database 140, if such space is not already provisioned (B300).

Next, the server 130 receives a user identified service selection from the client device 120 (B304). Then, the server 130 receives a user identified identity from the client device 120 (B306). In addition, the server 130 also receives a user identified role, or multiple roles, for the selected identity from block B306 (B308). After the server 130 receives the identified service, the identified identity and the identified role(s) from the client device 120, the server 130 sends out the associated service and associated role to the identity selection received in block B306 (B310). In response to the communication of block B310, acceptance of the service and role(s) is received from the identity selection from block B306 (B312). Finally, an indication is received that the selected identity has added the accepted identified service and role(s) to a stored list resident on the device operated by the selected identity (B313).

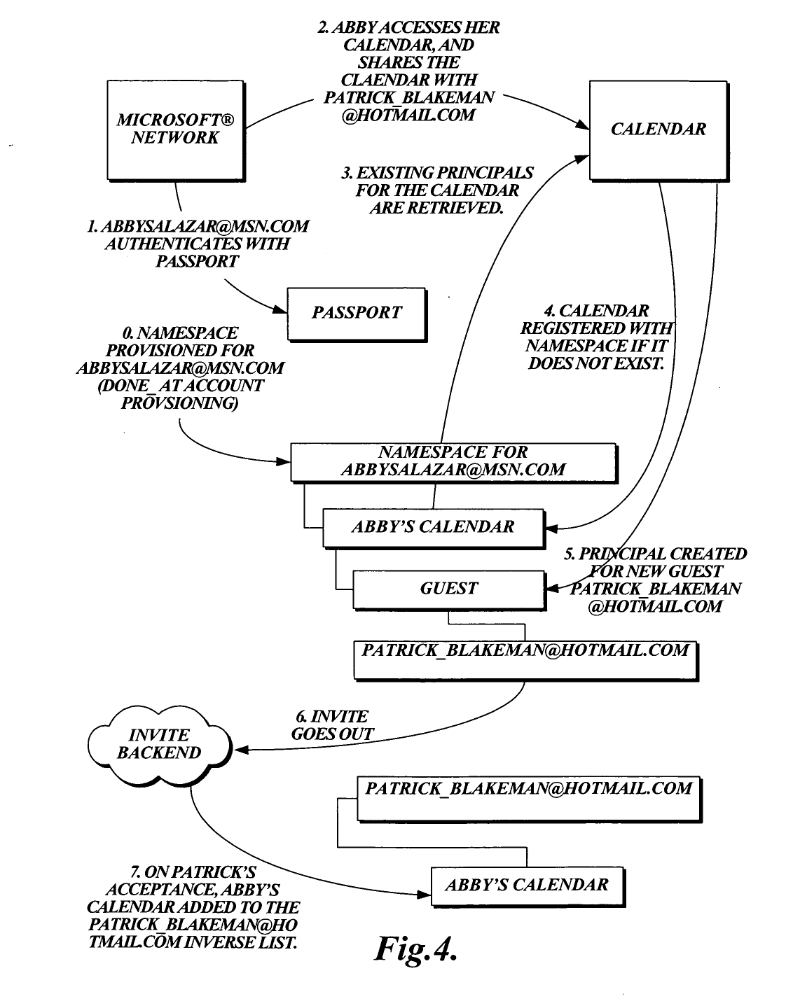

FIG. 4 illustrates a method of sharing a calendar using an exemplary embodiment of the present invention. As is illustrated in FIG. 4, a user (AbbySalazar@MSN.com) first gains access to an operating front end using an authentication process (point 1). In the figure, the front end is the Microsoft® Network, and the authentication process uses the Microsoft® .Net Passport method of authentication. However, any authentication process may be used with the exemplary embodiments of the present invention.

Next, the user accesses an associated calendar application. This calendar application may be built into the Microsoft® network, or some other front end associated with the authenticated user (point 2). Using the calendar interface, the user may identify one or more users that may share the contents of the calendar. The registration process generally requires the user to identify the service to be shared, in this case the calendar, the role(s) the shared user will have in conjunction with the shared service, and the identity information related to the entity with whom the calendar is to be shared (points 4 and 5). Examples of the roles that may be given include the right to read the calendar, the right to write or make changes to the calendar, and/or the right to see when the owner of the calendar is free and/or busy. In addition, any users that have sharing rights to the calendar are retrieved and annotated within the front end of the calendar.

The identity information referred to above may be an email address, a telephone number, or a Passport associated with the Microsoft® .Net Passport authentication system. Generally, the identity information may be any unique identifier that may be used to identify a user that is being given access to the user's (AbbySalazar@MSN.com) calender. Moreover, the identity information may also include the identity of more than one user that will have access to the calendar. For example, the user (AbbySalazar@MSN.com) can designate more than one person, or a group of individuals, that will have access rights to the calendar.

Once the service, role(s) and identity are identified, an invite is communicated to the user that is to have access to the calendar. In this case, the user's email address (Patrick_Blakeman@hotmail.com) is used to communicate the invite (point 6). Upon acceptance of the invite, resident memory/storage in the invitee's computer device stores an indication that the user has rights to the calendar (point 7).

In the case of the networked system 110 illustrated in FIG. 1, the client device 120 is operated by the user offering calendar access. The database 140 stores the information that the user of the client device 120 offers to share to other users. In this case, the database 140 stores the fact that AbbySalazar@MSN.com authorizes Patrick_Blakeman@hotmail.com the role of guest in conjunction with viewing of the calendar. The space designated in the database 140 for AbbySalazar@MSN.com may be referred to as a particular Namespace associated with the user (Point 0). This Namespace, or provisioned storage space, is normally established when AbbySlazar@MSN.com creates an account with the Microsoft Network®. However, the Namespace may also be provisioned when AbbySalazar@MSN.com first offers to share the calendar. The information that corresponds to the shared entities associated with Patrick_Blackeman@hotmail.com is stored in resident memory at the client device 160.

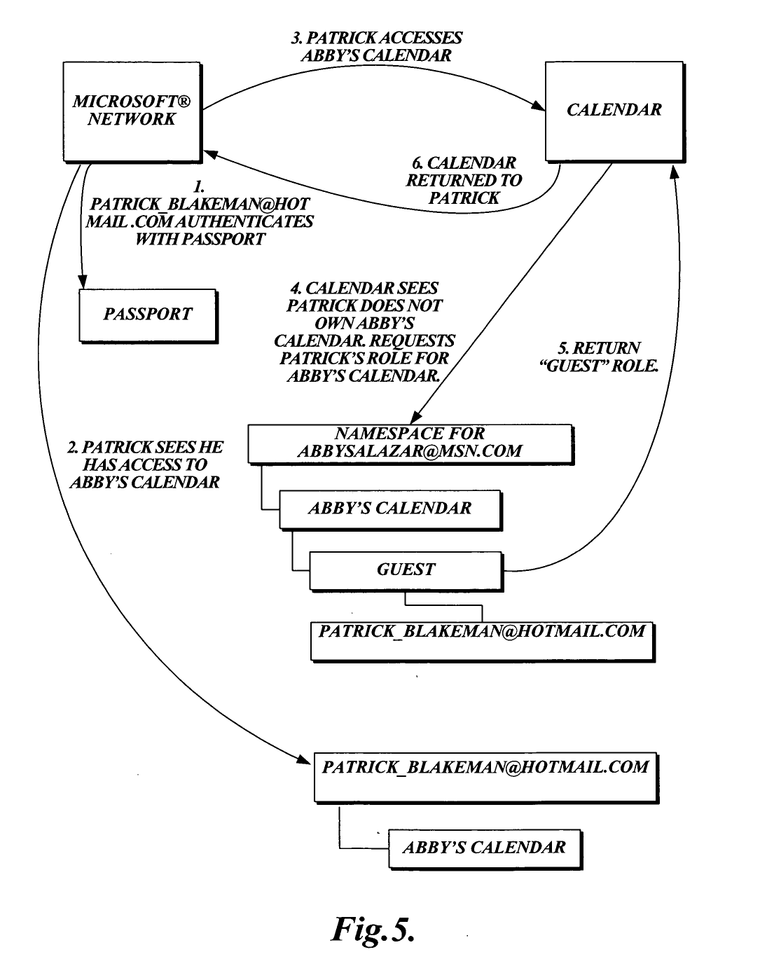

FIG. 5 illustrates the process by which an authorized user, having a particular assigned role(s), accesses the calendar. As is illustrated in FIG. 5, the user first authenticates into an operational front end using an authentication process (point 1). In the figure, the front end is the Microsoft® Network, and the authentication process uses the Microsoft® .Net Passport method of authentication. However, any authentication process may be used with the exemplary embodiments of the present invention.

Next, by way of the operational front end, the authorized user (Patrick_Blakeman@hotmail.com) sees access has been provided to another user's (AbbySalazar@MSN.com) calendar (point 2). At this point, the authorized user may access the calendar associated with AbbySalazar@MSN.com (point 3). In one scenario, the calendar associated with the sharing user determines that the authorized user is not the actual owner of the calendar, and requests the role, or roles, the authorized user has in association with the calendar (point 4). This role is returned to the owner's calendar (point 5). Finally, based on the authorized user's role, at least a portion of the calendar is returned to the front end associated with the authorized user (point 6). Again, examples of the roles that may be given include the right to read the calendar, the right to write or make changes to the calendar, and/or the right to see when the owner of the calendar is free and/or busy.

While the preferred embodiment of the invention has been illustrated and described, it will be appreciated that various changes can be made therein without departing from the spirit and scope of the invention.

APPENDIX
TABLE OF CONTENTS

| | |
|---|---|
| USING WEB SERVICES FOR ONLINE | 1 |
| PERMISSIONS | |
| Field of the Invention | 1 |
| Background of the Invention | 1 |
| Summary of the Invention | 2 |
| Brief Description of the Drawings | 3 |
| Detailed Description of Exemplary Embodiments | 3 |
| Abstract of the Disclosure | 13 |
| Appendix | 14 |
| Table of Contents | 14 |
| SOAP Protocol | 17 |
| SOAP API Overview | 17 |
| SOAP Header | 19 |
| Online Permission Classes | 22 |
| Namespace | 22 |
| Service | 25 |
| Membership | 30 |
| Member | 36 |
| Invitations | 42 |
| Identity | 46 |
| Principal | 48 |
| Annotations | 49 |
| Setting Annotations | 50 |
| Updating Annotations | 50 |
| Removing Annotations | 50 |
| Online Permission Methods | 50 |
| AddNamespace | 50 |
| DeleteNamespace | 52 |
| UpdateNamespace | 53 |
| FindNamespace | 54 |
| AddService | 55 |
| DeleteService | 57 |
| UpdateService | 58 |
| FindService | 60 |
| FindInverseService | 61 |
| AddInverseService | 63 |
| DeleteInverseService | 65 |
| AddMember | 66 |
| UpdateMember | 69 |
| SetMembership | 71 |
| DeleteMember | 73 |
| FindMembership | 75 |
| FindMembershipByRole | 78 |
| FindMembershipByMember | 81 |
| MemberHasRole | 85 |
| SendInvitation | 87 |
| AcceptInvitation | 88 |
| DeclineInvitation | 90 |
| AddPrincipal | 93 |
| DeletePrincipal | 95 |
| FindPrincipal | 96 |
| FindIdentityRoles | 100 |
| InviteIdentity | 103 |

### SOAP Protocol

### SOAP API Overview

| Method | Description |
|---|---|
| Namespace | |
| Management | |
| AddNamespace | Create a Namespace (used for persistent groups). |
| DeleteNamespace | Delete a Namespace. Deletes all Services, |
| | Identities, Contacts, and Groups associated with |
| | the Namespace. |
| | The service will maintain an age out policy for |
| | Namespacess. |
| UpdateNamespace | Update Namespace. Used to change the |
| | DisplayName or CreatorPassportName for a |
| | Namespace. |
| FindNamespace | Retrieve the properties of a Namespace. |
| Service Management | |
| AddService | Register a single Service in a Namespace. |
| DeleteService | Delete a single Service in a Namespace. This |
| | implicitly deletes all the Role Memberships |
| | associated to the Service. |
| UpdateService | Update the properties of a single Service. |
| FindService | Find all Services registered to a Namespace. |
| FindInverseService | Find all Services shared to an Identity. This is not |
| | the list of Services owned by the Identity, but |
| | rather the list of Services shared to an Identity. |
| | This list is maintained independently of the Role |
| | Memberships in the system. inverseInfo contains |
| | the Namespace, Service, and Role(s) in that |
| | Service. |
| | You must be the owner of the Inverse list to query |
| | it. |
| DeleteInverseService | Remove one or more Services from a Passport's |
| | inverse list. |
| | You must be the owner of the Inverse list to query |
| | it. |
| AddInverseService | Adds one service to a Passport's inverse list. You |
| | must be the owner of the Inverse list to add a |
| | service. |
| Role Management | |
| AddMember | Add one or more Members to a Role in a Service. |
| | Optionally, email notifications can be sent. |
| DeleteMember | Delete one or more Members from a Role in a |
| | single Service. |
| SetMembership | Assign a collection of Members to a given list of |
| | roles. |
| FindMembership | Find all services matching the given service filter |
| | with their included membership. |
| FindMembership- | Find all services matching the given service filter |
| ByRole | with their included membership for a particular |
| | role. |
| FindMembership- | Find the Roles of a Member for services in a |
| ByMember | specific Namespace, including membership |
| | recursion. |
| MemberHasRole | Determine if an Identity has a particular Role. |
| | Returns true/false. |
| Invite Management | Role Management methods also include invite |
| | related arguments. |
| SendInvitation | Used to resend invitations about the Service |
| | shared. |
| AcceptInvitation | Used to programmatically accept outstanding |
| | invitations. |
| DeclineInvitation | Used to programmatically decline outstanding |
| | invitations. |
| Additional Methods | |
| AddPrincipal | Add one or more Principals to a Service. |
| | Optionally, email notifications may be sent to |
| | those Identities. A subset of AddMember |
| DeletePrincipal | Delete one or more Principals from a single |
| | Service. This removes the Roles from the given |
| | Identities. A subset of DeleteMember. |
| FindPrincipal | Find all the Principals for one or more Services |
| | that I own. A subset of FindMembership & |
| | FindMembershipByRole. |
| FindIdentityRoles | Find the Roles of a single Identity for a single |
| | Service that I do not own. A subset of |
| | FindMembershipByMember. |
| InviteIdentity | Used to resend invitations to Identities about the |
| | Service shared to them. A subset of |
| | SendInvitation. |

### SOAP Header

Each method call to the system will be required to have additional properties passed in the SOAP header.

```
  <soap:Header>
    <ABApplicationHeader
xmlns=“http://www.msn.com/webservices/AddressBook”>
      <ApplicationId>guid</ApplicationId>
    </ABApplicationHeader>
    <ABAuthHeader
xmlns=“http://www.msn.com/webservices/AddressBook”>
      <ManagedGroupRequest>boolean</ManagedGroupRequest>
      <CallerIdentification>
        <CallerPassportId>long</CallerPassportId>
        <CallerPassportName>string</CallerPassportName>
      </CallerIdentification>
    </ABAuthHeader>
  </soap:Header>
```

Application Header

Used to identify the application calling the method.

This header is REQUIRED on calls.

public class ABApplicationHeader : SoapHeader
{
public System.Guid ApplicationId;
}

| Property Name | Description |
|---|---|
| ABApplicationHeader.ApplicationId | GUID to identify the |
| | system partners. |

Authentication Header

ManagedGroupRequest is required.

public class ABAuthHeader:

```
System.Web.Services.Protocols.SoapHeader
    {
        public bool ManagedGroupRequest;
        public IdentificationHeader CallerIdentification;
    }
```

| Property Name | Description |
|---|---|
| ManagedGroupRequest | If this SOAP request is a read, write, or |
| | provision request by the parent to a |
| | managed child account, this flag must be |
| | set to true. |
| | Note: The parent account has full access |
| | to the childs account (managed account) |
| | address book. |
| | This flag is required as an optimization |
| | for the system frontend. |
| CallerIdentification | Addition Header used to indicate the |
| | Identity of the user this call is being |
| | made on behalf of. This header is used |
| | by Partner applications when they are |
| | making a call to a Group Namespace or |
| | when they are calling an Addressbook |
| | when the caller is NOT the owner of the |
| | addressbook. |

### Online Permission Classes

### Namespace

Properties of a Namespace

| Property Name | Description |
|---|---|
| NamespaceHandle.Id | The system associates a unique GUID |
| | with each Namespace. |
| | If the Namespace is for an individual |
| | user, this GUID is a zero filled Passport |
| | PUID. |
| | If the Namespace is for a Group, this |
| | GUID is randomly generated. |
| | Only one Namespace may be created |
| | per PUID. |
| | PUID Decimal |
| | 281547719894151 |
| | PUID Hex |
| | 0x10010efd4e487 |
| | PUID zero filled abId |
| | 00000000-0000-0000-0001- |
| | 0010efd4e487 |
| Namespace.Changes | Only used in Update. Set by the caller |
| | to indicate which fields should be |
| | updated. In the first release, only the |
| | name can be updated. |
| Namespace.CreateDate | The date the Namespace was created. |
| | System generated. |
| Namespace.LastChange | Format: GMT. ISO 8601 format. |
| | Purpose: Used by partners that keep a |
| | local cache of the contents of the |
| | Namespace. |
| NamespaceInfo.DisplayName | Friendly name for the Namespace. Not |
| | required. Not unique. |
| NamespaceInfo.CreatorPuid | Passport PUID of the owner of the |
| | Namespace. Used when provisioning |
| | the Namespace. |
| | Must be passed as a decimal in the |
| | XML of the request. Cannot be passed |
| | as a hex string. |
| NamespaceInfo.CreatorPassport | 321 char max. If length is exceeded, |
| Name | value is truncated. |
| | Email address of the owner of the |
| | Namespace. Used for notifications and |
| | other purposes. |

C#—Namespace Related Classes

public enum NamespacePropertyTypes
{

DisplayName = 1

}
public class NamespaceHandle
{

| | |
|---|---|
| public System.Guid | Id; |
| public string | PassportName; |

}
public class NamespaceInfo
{

| | |
|---|---|
| public NamespaceHandle | Handle; |
| public string | DisplayName; |
| public long | CreatorPuid; |
| public string | CreatorPassportName; |

}
public class Namespace
{

| | |
|---|---|
| public NamespaceInfo | Info; |
| public NamespacePropertyTypes | Changes; |
| public System.DateTime | CreateDate; |
| public System.DateTime | LastChange; |

}

Age-Out Policy

Aging policy:
1. After a fixed period of inactivity, the Namespace will be deleted.
2. This data cannot be retrieved again after deletion.

### Service

Services are data or resources stored outside the system. Example: Calendars, Files, Photos, Favorites, Address Books, Alert History, . . . .

Properties of a Service

| Property Name | Description |
|---|---|
| ServiceHandle.Id | Unique ID of the Service. Integer. |
| | Generated by the service. Unique |
| | within the Namespace. |
| ServiceHandle.Type | The nature of the Service being |
| | registered. Each service type is |
| | represented by an enumeration value. |
| | Some Service types may only be |
| | allowed once per Namespace. |
| | ServiceType.Namespace // Space |
| | ServiceType.Calendar // Shared |
| | Calendar |
| | ServiceType.Folder // Shared online |
| | files |
| | ServiceType.Space // Circle service |
| | ServiceType.MessageContainer // Blog |
| | service |
| | ServiceType.PhotoAlbum // Photo |
| | Album service |
| | ServiceType.List // List service |
| | This list is extensible. |
| ServiceHandle.ForeignID | The unique ID used by the Service |
| | Provider to identify the Service. Each |
| | Service Provider my have it's own |
| | format for the ID. The system only |
| | stores the ID, and applies no semantics |
| | to it. |
| | ServiceHandle.ForeignID is unique per |
| | namespace. |
| | If the ServicHandle.ForeignID is in fact |
| | the PUID of the user, and that user is |
| | the same as the owner of the |
| | namespace (puid owned address book), |
| | then the ForeignID should be an empty |
| | string. Otherwise, the PUID will be |
| | passed in the clear on role and inverse |
| | list requests. |
| | Cannot be null, use an empty string |
| | instead. This helps with simplifying |
| | the backend. |
| ServiceInfo.DisplayName | The friendly name applied to that |
| | instance of the service. No locale is |
| | kept for this field - it will be stored as |
| | Unicode characters. It is not advisable |
| | to leave this field null, as this |
| | information is also stored in the inverse |
| | lookup for the Service. |
| ServiceInfo.InverseRequired | If true, an inverse lookup is maintained |
| | for this Service. |
| | If an inverse lookup is maintained for a |
| | Service, invites are mandatory when |
| | adding a Principal to a Service. See |
| | AddPrincipal. |
| ServiceInfo.Url | URL that can be used to display this |
| | Service in an IFRAME. |
| ServiceInfo.Memberships | Collection of Memberships and |
| | associated Members under this Service |
| ServiceInfo.Annotations | Name/Value pairs associated with the |
| | Service itself See Annotations section |
| | for more information. In v10, the |
| | system does not have any pre-defined |
| | annotations associated with Services. |
| | Initially the Annotation field of is set |
| | to Null. |
| Service.Changes | Only valid on update operations - |
| | indicates which fields should be |
| | updated. |
| Service.LastChange | The date/time of the last update to the |
| | Role Mappings in this Service. |

C#—Service Related Classes

public enum ServiceType
{

| Namespace | = 1, | |
|---|---|---|
| Calendar | = 2, | |
| Folder | = 3, | |
| ContactInfo | = 4, | |
| AddressBook | = 5, | |
| Favorites | = 6, | |
| Messenger | = 7, | |
| Space | = 8, | // Space |
| MessageContainer | = 9, | // Message Container (Blog) |
| PhotoAlbum | = 10, | // Photo Album |
| List | = 11, | // Shared List |
| ABCHInternal | = 12, | |
| Invitation | = 13 | |

// This list is extensible
}

[Flags]

public enum ServicePropertyTypes
{

| | |
|---|---|
| DisplayName | = 0x01, |
| Url | = 0x02, |
| Annotation | = 0x04 |

}
public class ServiceHandle
{

| | |
|---|---|
| public short | Id; |
| public ServiceType | Type; |
| public string | ForeignId; |

}
public class ServiceInfo
{

| | |
|---|---|
| public ServiceHandle | Handle; |
| public string | DisplayName; |
| public bool | |

InverseRequired;

| | |
|---|---|
| public string | Url; |
| public Annotation[ ] | Annotations; |

}
public class Service
{

| | |
|---|---|
| public ServiceInfo | Info; |
| public Membership[ ] | Memberships; |
| public ServicePropertyTypes | Changes; |
| public System.DateTime | LastChange; |
| public bool | Deleted; |

}
public class ServiceFilter
{

| | |
|---|---|
| public ServiceType[ ] | Types; |
| public ServiceHandle[ ] | Handles; |
| public System.DateTime | LastChange; |

}
public class ServiceLocation
{

| | |
|---|---|
| public NamespaceHandle | NamespaceHandle; |
| public ServiceInfo | ServiceInfo; |
| public System.DateTime | LastChange; |

}

### Membership

Properties of a Membership

| Property Name | Description |
|---|---|
| RoleId | Enumeration used to identify a Role. |
| | System defined. Values: |
| | Admin |
| | AssistantAdmin |
| | Member |
| | Guest |
| | Banned |
| | Delegate |
| | Allow |
| | Block |
| | Reverse |
| | Pending |
| | CalFreeBusy |
| | Contributor |
| | This list is extensible. |
| Membership.MemberRole | RoleId of this membership. |
| Membership.Members | Array of Members to add to the specified |
| | Role |
| Membership.LastChanged | Last changed datetime - not used in v10 |

C#—Role Related Classes

public enum RoleId
{

| | |
|---|---|
| Admin | = 1, |
| AssistantAdmin | = 2, |
| Member | = 3, |
| Guest | = 4, |
| Banned | = 5, |
| Delegate | = 6, |
| Allow | = 7, |
| Block | = 8, |
| Reverse | = 9, |
| Pending | = 10, |
| CalFreeBusy | = 11, |
| Contributor | = 12, |
| NamespaceQuota | = 13 |

}
public class Membership
{

public RoleId Id;
public Member[ ] Members;

}

Standard Roles

To alleviate the burden of each Service Provider creating common Roles for their Services, the system will provide Standard Roles.

The Standard Roles apply system wide. All identities and memberships across the entire system use the same set of Roles.

There will be 5 standard roles available:
Administrator—Unrestricted access.
Assistant Administrator—Same privileges as Administrator, but cannot delete the Service itself.
Member
Read/Write access, but cannot delete the Service itself, and may not have some Administrator privileges. For example, a user of a shared folder can add or delete files in the folder, but cannot delete the folder itself. Can invite others.
Contributor—Read/Write access, but cannot delete the Service itself, and may not have some Administrator privileges. For example, a user of a shared folder can add or delete files in the folder, but cannot delete the folder itself. Cannot invite others.
Guest—Read access.
Banned—Explicitly prevented from accessing the Service.
Delegate—Can manage the Role Mapping, but otherwise does not have access to the Service. Similar to an Outlook Delegate.

These are suggested Roles for use by our Service Providers. They are intended to prevent each Service from creating their own Roles that essentially duplicate common Roles.

Standardized Roles do not have to be created before assigning an Identity to the Role.

Custom Roles

Service Providers need the ability to extend the Standard Roles for privileges specific to the Service Provider's application. For example, a Calendar service may wish to have a Role for users that can reschedule appointments, but not add or delete them.

Service Providers should not create Custom Roles that duplicate the intent of the Standardize Roles. This increases the probability that existing Role/Identity associations can be reused by other Service Providers.

In addition to the existing standard roles, new roles will be defined to support Messenger:
Allow
Block
Reverse
Pending

Additionally, a new role has been added to support Namespace quota tracking: OwnedNamespace.

Querying Roles

All the Roles available to assign can be retrieved from the system. Service Providers can view the Roles created by another Service Provider.

Role Capabilities

Namespace Service

The following rules must be enforced by the system based on roles identified in the Namespace service.

The roles defined in the tables below are the only roles recognized and enforced by the system specifically for the described system services. The system does not define behavior associated w/roles for other services using the system methods. This does not preclude other services from using the same roles in a different manner. One would expect that elevated roles such as Admin would have an elevated level of access across all services, but it is completely up to the app assigning the role as to what privileges are enforced. In addition, other custom roles defined in this document that do not appear in the table below, have no privileges to carry out Namespace or Addressbook activities.

If a member is in multiple roles, the highest role “wins”. Highest in this case corresponds to the roles position in the tables below. Example: If a member is an Administrator and a Guest, the member will be treated as an Administrator by the system. The banned role is not enforced for the capabilities feature. In other words if a member is an Admin and they are banned, then they are an admin.

Add Methods:

| | | AddMember | | | |
|---|---|---|---|---|---|
| Role | AddNamespace | UpdateMember | AddService | SendInvitation | AddInverseService |
| Administrator | n/a - not role- | Can add/update anyone | Can perform | Can invite anyone | Can perform |
| | driven | | | | |
| Asst. | n/a - not role- | Can add/update anyone | Can perform | Can invite anyone | Can perform |
| Administrator | driven | EXCEPT Administrators | | EXCEPT | |
| | | | | Administrators | |
| Member | n/a - not role- | Can ONLY add/update | Can perform | Can ONLY invite | Can perform |
| | driven | other Members, | | other Users and | |
| | | Contributors, and Guests | | Guests | |
| Contributor | n/a - not role- | Cannot perform | Cannot | Cannot perform | Can perform |
| | driven | | perform | | |
| Guest | n/a - not role- | Cannot perform | Cannot | Cannot perform | Can perform |
| | driven | | perform | | |

Delete Methods:

| Role | DeleteNamespace | DeleteMember | DeleteService | DeleteInverseService |
|---|---|---|---|---|
| Administrator | Can perform | Can delete anyone | Can perform | Can perform |
| Asst. | Cannot perform | Can delete self, | Can perform | Can perform |
| Administrator | | Members, | | |
| | | Contributors, and | | |
| | | Guests | | |
| Member | Cannot perform | Can delete self, | Can perform | Can perform |
| | | but cannot delete | | |
| | | anyone else | | |
| Contributor | Cannot perform | Can delete self, | Cannot | Can perform |
| | | but cannot delete | perform | |
| | | anyone else | | |
| Guest | Cannot perform | Can delete self | Cannot | Can perform |
| | | | perform | |

Find & Update Methods:

| | | | | FindInverseService | |
|---|---|---|---|---|---|
| | | FindMembership | | MemberHasRole | |
| | | FindMembershipBy | | FindMembershipBy | |
| Role | FindNamespace | Role | FindService | Member | UpdateService |
| Administrator | Can perform | Can perform | Can perform | Can perform | Can perform |
| Asst. | Can perform | Can perform | Can perform | Can perform | Can perform |
| Administrator | | | | | |
| Member | Can perform | Can perform | Can perform | Can perform | Can perform |
| Contributor | Can perform | Can perform | Can perform | Can perform | Can perform |
| Guest | Can perform | Can perform | Can perform | Can perform | Cannot perform |

Banned Role

The Banned role, although not enforced like others are via capabilities, can still be used by partners to “track” a list of banned members from the service. This is due to the fact that users in the Banned role does not have ANY capabilities against the Namespace like Administrators, Asst. Administrators, etc.

HOWEVER, if a user is BOTH Banned and an Administrator, he/she WILL have Administrator capabilities. This is what we mean by not enforcing Banned.

Declined Identities

If a Member has a state of Declined, the Member cannot perform any of the actions indicated above with the exception of AddNamespace, since it is not tied to any particular instance of a Namespace.

A Member must be Pending or Accepted in the Namespace service in order to perform the actions indicated above.

### Member

Properties of a Member

| Property Name | Description |
|---|---|
| MemberType | Enumeration used to designate the Type of the |
| | Member. |
| | Passport |
| | Phone |
| | Email |
| | Everyone |
| | Group |
| | Guid |
| | Role |
| | Partner |
| MemberState | Enumeration used to designate the State of the |
| | Member. Values: |
| | Pending |
| | Declined |
| | Accepted |
| | Removed |
| MemberPropertyTypes | Enumeration of property types used in system |
| | when specifying Changes. |
| | State |
| | Annotations |
| | DisplayName |
| Member.MembershipId | Integer identifier for the Member's |
| | Membership. Generated by SQL. Unique |
| | within the Namespace. |
| Member.Type | MemberType indicating the type of Member. |
| Member.Location | NamespaceHandle indicating the location of |
| | the Member. When referencing your own |
| | Namespace, Location should be null. |
| | Location MUST be null since the system does |
| | not permit cross-namespace references. |
| Member.DisplayName | Friendly name of the member. Optional. |
| Member.State | MemberState. See above. |
| Member.Annotations | Name/Value pairs associated with the Member |
| | itself. See Annotations section for more |
| | information. The system does not have any |
| | pre-defined annotation names associated with |
| | Members. |
| Member.Deleted | Tombstone indicating whether or not this |
| | Member has been deleted. Used in delta |
| | synchronization. |
| Member.LastChanged | LastChanged timestamp. Only used on output. |
| Member.Changes | Only used in UpdateMember. Set by the |
| | caller to indicate which fields should be |
| | updated. In the first release, only the state |
| | and the annotations can be updated. |
| PhoneMember.PhoneNumber | PhoneIdentity is derived from Identity. For |
| | PhoneIdentities, this is the actual Phone Number. |
| EmailMember.EmailAddress | EmailIdentity is derived from Identity. For |
| | EmailIdentities, this is the actual Phone Number. |
| PassportMember.Passport | PassportIdentity is derived from Identity. For |
| | PassportIdentities, this is the actual Member Name. |
| PassportMember.PassportId | For PassportIdentities, this is the actual PUID |
| | associated with the Member Name. The |
| | PUID will not be returned to partners over the |
| | Public Front-end. |
| GroupMember.Id | ID of the Group in the current Namespace |
| | referenced by the GroupMember. |
| ServiceMember.DefiningService | ServiceHandle. Used to indicate the location |
| | of the service the membership resides in. |
| GuidMember.Id | ID of the Namespace or other GUID-based entity. |
| RoleMember.Id | RoleId. Used to indicate which Role is |
| | referenced by the RoleMember. |
| RoleMember.DefiningService | ServiceHandle. Used to indicate the location |
| | of the service the membership resides in. |
| RoleMember.MaxRoleTargetDepth | For recursive memberships, how many levels deep to go. |
| RoleMember.MaxDegreesSeparation | Maximum levels of separation. |

C#—Member Related Classes

public enum MemberType : byte
{

| | |
|---|---|
| Passport | = 1, |
| Everyone | = 2, |
| Phone | = 3, |
| Email | = 4, |
| Group | = 5, |
| Guid | = 6, |
| Role | = 7, |
| Service | = 8 |

}
public enum MemberState : byte
{

| | |
|---|---|
| Pending | = 1, |
| Declined | = 2, |
| Accepted | = 3, |
| Removed | = 4 |

| } | |
|---|---|
| [Flags] | |
| public enum MemberPropertyTypes | |
| { | |
| State | = 0x01, |
| Annotations | = 0x02, |
| DisplayName | = 0x04, |

```
  }
public abstract class Member
{
    public MemberPropertyTypes Changes;
    public int MembershipId;
    public MemberType Type;
    public NamespaceHandle Location;
    public string DisplayName;
    public MemberState State;
    public Annotation[ ] Annotations;
    public bool Deleted;
    public System.DateTime LastChanged;
}
public class GroupMember : Member
{
    public System.Guid Id;
}
public class GuidMember : Member
{
    public System.Guid Id;
}
public class ServiceMember : Member
{
    public ServiceHandle Service;
}
public class RoleMember : Member
{
    public RoleId Id;
    public ServiceHandle DefiningService;
    public int MaxRoleRecursionDepth;
    public int MaxDegreesSeparation;
}
public class EveryoneMember : Member
{
}
public class PhoneMember : Member
{
    public string PhoneNumber;
}
public class EmailMember : Member
{
    public string Email;
}
public class PassportMember: Member
{
    public string PassportName;
    public long PassportId;
}
```

### Invitations

Invitations are not first class objects in the API. Options can be specified for the invitation, but a handle for the invitation itself cannot be retrieved.

Invitations can be sent via email or by placing an entry in the Pending role of the Invitation service of the invitee (called the “Invitation Pending List” below). Email-based invitations are per ServiceType and require a template.

See Example Scenario and Invitation Service below for more detail on PendingRole-based invitations.

Accept/Decline

When an invitation is sent (through SendInvitation, SetMembership, or AddMember), the system will do the following:
Add the Identity as Pending in the Service (in this case Service: Namespace) as we do today.
If email-based, send the email using the appropriate template for the service as we do today.

If Pending Role-based, add a ServiceMember entry to the Pending role in the Invitation Service in the recipient's PUID-based Namespace.

Note: Partners can send BOTH pending role and email based invitations at once.

In order to accept the invitation, the client will have to:
Use the existing ticketing system built into the email URLs. Or . . .
Call AcceptInvitation, which will set the MemberState in the original Namespace to Accepted, and add an entry in the user's Inverse List.
   The system will also do the equivalent of DeleteMember to remove the entry from the Pending role in the Invitation Service once the AcceptInvitation is successful.

In order to decline, the client would have to:
Use the existing ticketing system built into the email URLs. Or . . .
Call DeclineInvitation, which will set the MemberState in the original Namespace to Declined.
The system will also do the equivalent of DeleteMember to remove the entry from the Pending role in the Invitation Service once the DeclineInvitation is successful
   Invitation Service

Invitations can be sent via email (DeliveryType=Email described below) or by placing a ServiceMember entry in the Pending role of the Invitation service in the invitee's Namespace (Delivery Type=PendingRole).

This “Invitation Pending List” can be used by partners to query for outstanding invitations sent to a particular identity/PUID to be shown in Messenger, on the web, etc. Partners can then programmatically accept or decline these invitations via AcceptInvitation and DeclineInvitation.

If the invitee's Namespace does not exist, it will be provisioned during the call.

If the Invitation Service does not exist in the invitee's Namespace, the Service will be created. ServiceInfo.InverseRequired will be false.

If the ServiceMember is already in the Pending role in the contact's Namespace, this is not an error. If the invitee's database is not available, the call will throw an exception.

If the pending list has filled the quota, the newest Identity (most recently added) will be deleted.

Properties of Invite Options

| | | | | If not | Max |
|---|---|---|---|---|---|
| Option Name | Type | Description | Required? | required? | size |
| UserText | String | Text the user will | No | Pass Null | 1024 |
| | | see embedded in | | | |
| | | the invitation | | | |
| | | email. | | | |
| Market | String | The market (see | Yes | N/A | 6 |
| | | below) of the | | Error will | |
| | | invite locale. | | be | |
| | | | | returned if | |
| | | | | not | |
| | | | | supplied. | |
| InviterName | String | Name of the | No | Pass Null | 64 |
| | | person sending the | | The email | |
| | | invite. | | “From” | |
| | | | | field will | |
| | | | | consist of | |
| | | | | just the | |
| | | | | email | |
| | | | | address. | |
| | | | | Example: | |
| | | | | <miketor1 | |
| | | | | @hotmail. | |
| | | | | com> | |
| CustomMarketing | String | Variable used by | No | Pass Null | 256 |
| | | email templates to | | | |
| | | change the UI/text | | | |
| | | of an email. | | | |
| CoBrand | String | URL for market- | No | Pass Null | 32 |
| | | specific link | | | |
| Type | DeliveryType | Used to signify the | No | The | 1 |
| | | type of invitation | | default | |
| | | that should be sent. | | type is | |
| | | Email and | | EMAIL | |
| | | PendingRole are | | | |
| | | the only options. | | | |
| | | Both at once are | | | |
| | | allowed. | | | |

C#—Invite Related Classes

[Flags]

| public enum DeliveryType | |
|---|---|
| { | |
| Email = | 0x01, |
| PendingRole = | 0x02 |

| } | |
|---|---|
| public class InviteOptions | |
| { | |
| public string | UserText; |
| public string | Market; |
| public string | InviterName; |
| public string | CustomMarketing; |
| public string | CoBrand; |
| public DeliveryType | Type; |
| } | |

### Identity

A person or group (or classification).

Properties of an Identity

These properties are supplied by the caller.

| Property Name | Description |
|---|---|
| Identity Type | The class of identity. |
| IdentityHandle.Type | |
| Identity name | For Identities of type IdentityType.User, the |
| IdentityHandle.Name | name is the Passport Member Name of the |
| | user that is being assigned this Role. |
| | For Identities of type IdentityType.Group, |
| | this is the name of the Group. |
| PUID | For Identities of type IdentityType.User, the |
| IdentityHandle.Puid | PUID associated with the Passport member |
| | name. |
| Identity State | Invitation state. Also may indicate when the |
| IdentityInfo.State | reverse lookup for this identity no longer |
| | contains a back pointer to the service. |
| | IdentityState.Pending |
| | IdentityState.Declined |
| | IdentityState.Accepted |
| | IdentityState.Removed |
| Identity Display Name | The display name of the Identity. Not |
| IdentityInfo.DisplayName | required. |

C#—Identity Related Classes

| public enum IdentityType | |
|---|---|
| { | |
| User = 1, | |
| Everyone = 2 | |
| } | |
| public enum IdentityState | |
| { | |
| Pending | = 1, |
| Declined | = 2, |
| Accepted | = 3, |
| Removed | = 4, |

| } | |
|---|---|
| public class IdentityHandle | |
| { | |
| public IdentityType | Type; |
| public string | Name; |
| public long | Puid; |
| } | |
| public class IdentityInfo | |
| { | |
| public IdentityHandle | Handle; |
| public IdentityState | State; |
| public string | DisplayName; |

| } | |
|---|---|
| public class Identity | |
| { | |
| public IdentityInfo | Info; |
| public System.DateTime | LastChange; |

}
public class IdentityFilter
{
public IdentityHandle[ ] Handles;
}

### Principal

A principal represents the association of a single Identity and set of Roles.

An Identity cannot be in the same Role more than once.

Properties of a Principal

These properties are supplied by the caller.

| Property Name | Description |
|---|---|
| Identity | (see description of Identity above) |
| Identity Type | |
| Identity Namespace | |
| Collection of Roles | (see description of Role above) |
| Role Id | |

C#—Principal Related Classes

```
public class Principal
{
      public IdentityInfo IdentityInfo;
      public int[ ] RoleIds;
}
public class PrincipalFilter
{
      public IdentityHandle[ ] IdentityHandles;
      // - or -
      public RoleId[] RoleIds;
}
```

### Annotations

Annotations are Name Value Pairs (NVPs) that can be associated with Services and Members (or other objects in the future). All Annotations will be fully accessible by all partners.

There is NO validation on the value fields of an annotation. Any string value can be applied to any annotation type. There is 1K limit on the size of an annotation value.

The following properties will be associated with an Annotation:

```
public class Annotation
{
      public string Name;
      public string Value;
}
```

```
<Contact>
  ...
  <contactInfo>
  ...
  <annotations>
  <Annotation>
        <Name>string</Name>
        <Value>string</Value>
  </Annotation>
  </annotations>
  ...
  </contactInfo>
  ...
</Contact>
```

### Setting Annotations

In order to set annotation(s), pass the Annotation name with a corresponding value to AddMember, AddService, SetMembership or UpdateMember. Any previous value associated with this name will be overwritten.

### Updating Annotations

In order to update annotation(s), pass the Annotation name with the new value for the annotation to UpdateService or UpdateMember. Since only one annotation of a particular name can exists, this will update the value for the existing annotation.

### Removing Annotations

In order to remove annotation(s), pass the Annotation name with a corresponding value of null to UpdateService or UpdateMember. This will remove the annotation.

### Online Permission Methods

### AddNamespace

A Namespace is a parent container for Services, Role Mappings, Contacts and AB Groups.

AddNamespace will create a Namespace service which will serve as the default service and automatically add the owner to the RoleId(s) specified. The owner of a Namespace is the individual who created the namespace (the user calling the Addnamespace method). The PUID of the owner is determined by the passport cookie passed in. An entry will automatically be added in the ownerPuid's Inverse List.

You MUST be authenticated as the ownerPuid in order to complete the Add. In other words, you may not provision a Namespace on behalf of another user.

Method Signature

```
public Guid AddNamespace(
  NamespaceInfo nsInfo,
  RoleId[ ] roleIds
)
```

Parameters

Information specific to this method is listed here. The rest of the information on the fields can be found in the appropriate sections at the beginning of the document.

[hdr] Application Header

See the SOAP Header section for more information.

[in] nsInfo

Properties for the Namespace.

.DisplayName
The friendly name for the Namespace. Does not have to be unique.
The DisplayName is stored with the Service entry for the Namespace, and NOT stored in the Namespace properties itself.

.CreatorPuid
If null, the system will query for the PUID value based on the HTTP headers.
The CreatorPuid is never copied to the inverse list for any user sharing this Namespace.

.CreatorPassportName
The Passport member name of the user creating this Namespace. This member name will be added as an Administrator of the Namespace.

[in] namespaceHandle

Identifies the Namespace to delete.

.NamespaceID
The GUID for this namespace.

.PassportName
Not used. If sent, a fault will be returned: Bad Argument NamespaceHandle cannot contain both NamespaceId and PassportName values.

roleIds

An array of roleIds to automatically add the owner PUID to. Cannot be null.

[return] Guid

Guid for the Namespace.

Automatic Roles

When a user provisions a Namespace in the system from Messenger or the Spaces experience, he/she must indicate the initial roles to add him/herself to.

This gives the creator the flexibility to create a Namespace in which she is an Administrator and/or a standard member of appropriate capabilities. The creator will be added as a member of type IdentityMember.

The owner will not have any special capabilities by nature of the fact that she is an owner; it will all be driven by which role she is in.

Owner Puid Inverse List

An entry will automatically be added in the ownerPuid's Inverse List for the newly created Namespace service.

Service ID for Namespace Service

The Service ID for the Namespace service is not returned by AddNamespace.

### DeleteNamespace

Delete a Namespace. Deletes all Services, Members, Contacts, and Groups associated with the Namespace.

There are two ways a Namespace can be deleted. Either through aging out the Namespace, or through an explicit delete.

Method Signature

public void DeleteNamespace(
NamespaceHandle nsHandle
)

Parameters

Information specific to this method is listed here. The rest of the information on the fields can be found in the appropriate sections at the beginning of the document.

[hdr] Application Header

See the SOAP Header section for more information.

[in] nsHandle

Identifies the Namespace to delete.

.NamespaceID
The GUID for this namespace.

.PassportName
Not used. If sent, a fault will be returned: Bad Argument NamespaceHandle cannot contain both NamespaceId and PassportName values.

[return] void

Status is returned in the SOAP response.

Inverse Synchronization Policy

Inverse list policy: When the namespace is deleted, the inverse list entries for all the identities are NOT removed. The inverse list entries are also NOT marked with an IdentityState.Removed in the inverse list.

### UpdateNamespace

Update Namespace properties.

Method Signature

public void UpdateNamespace(
Namespace ns,
)

Parameters

Information specific to this method is listed here. The rest of the information on the fields can be found in the appropriate sections at the beginning of the document.

[hdr] Application Header

See the SOAP Header section for more information.

[in] ns

Properties for the Namespace.

.info.DisplayName
The friendly name for the Namespace. Does not have to be unique.

[in] namespaceHandle

Identifies the Namespace to update.

.NamespaceID
The GUID for this namespace.

.PassportName
Not used. If sent, a fault will be returned: Bad Argument NamespaceHandle cannot contain both NamespaceId and PassportName values.

[return] void

### FindNamespace

Find a Namespace based on one or more namespaceHandles. Use FindNamespace to retrieve Namespace properties.

Note: This method allows you to find the properties of a Namespace given the handle for the Namespace. For each handle, there will be one Namespace returned (assuming the handle was valid).

DisplayName will not be returned through this method.

Method Signature

public Namespace[ ] FindNamespace(
NamespaceHandle[ ] nsHandles
)

Parameters

Information specific to this method is listed here. The rest of the information on the fields can be found in the appropriate sections at the beginning of the document.

[hdr] Application Header

See the SOAP Header section for more information.

[in] nsHandles

Identifies the Namespaces to find.

.NamespaceID
The GUID for this namespace.
If this is a Namespace that belongs to a Passport, use ABFind instead.

.PassportName
Not used. If sent, a fault will be returned: Bad Argument NamespaceHandle cannot contain both NamespaceId and PassportName values.

[return] Namespace[ ]

Returns the Namespace properties. DisplayName will NOT be returned.

Returns null if the Namespace does not exist (is not provisioned). An exception is not returned in this case.

### AddService

Register a single Service in a Namespace.

ServiceID is returned from AddService.

A service of type Namespace CANNOT be added through AddService.

The caller MUST be Passport authenticated and have access to the specified Namespace.

Method Signature

```
public short AddService(
  NamespaceHandle nsHandle,
  ServiceInfo serviceInfo
)
```

Parameters

Information specific to this method is listed here. The rest of the information on the fields can be found in the appropriate sections at the beginning of the document.

[hdr] Application Header

See the SOAP Header section for more information.

[in] nsHandle

.NamespaceID
Target namespace.

.PassportName
Not used. If sent, a fault will be returned: Bad Argument NamespaceHandle cannot contain both NamespaceId and PassportName values.

[in] serviceInfo

Identifies the Service to add and the new properties.

NOTE: The type/ForeignID combination will be enforced to be unique.

.Handle.ID
Must be 0

.Handle.Type
Must be one of the ServiceType enumerations.

.Handle.ForeignID
The unique ID used by the Service Provider to identify the Service.
Use an empty string instead of null, since null directs the method to use the Handle.Id.
May be an empty string if the Service Provider uses the PUID to identify the Service, and this Namespace is a PUID owned Namespace (fDefault=true). Service Providers MUST NOT store the PUID in this field, as this field is passed in the clear during the SOAP requests.

.DisplayName
Optional. Friendly name for this Service.

.InverseRequired
If true, an inverse lookup is maintained for this Service.
This parameter is necessary.

.Url
Optional. URL that can be used to display this Service in an IFRAME.

[return] short

Unique ID of the service—for use in ServiceHandle.

Memberships

The Memberships array in ServiceInfo MUST BE null when calling AddService.

### DeleteService

Delete one Service in a Namespace. This implicitly deletes all the Role Mappings associated to the Service.

DeleteService will delete EVERYTHING associated with the service including Memberships and associated Members.

The caller MUST be Passport authenticated and have access to the specified Namespace.

Method Signature

```
public void DeleteService(
  NamespaceHandle nsHandle,
  ServiceHandle serviceHandle
)
```

Parameters

[hdr] Application Header

See the SOAP Header section for more information.

[in] nsHandle

.NamespaceID
Target namespace.

.PassportName
Not used. If sent, a fault will be returned: Bad Argument NamespaceHandle cannot contain both NamespaceId and PassportName values.

[in] serviceHandle
If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.ID
ID of the Service. Highly Recommended.

—Or—

The type and foreign id of the target Service.

NOTE: The type/ForeignID combination will be enforced to be unique.

.Type
Must be one of the ServiceType enumerations.

.ForeignID
The unique ID used by the Service Provider to identify the Service.
Use an empty string instead of null, since null directs the method to use the Handle.Id to identify the service.

May be an empty string if the Service Provider uses the PUID to identify the Service, and this Namespace is a PUID owned Namespace (fDefault=true). Service Providers MUST NOT store the PUID in this field, as this field is passed in the clear during the SOAP requests.

[return] void

Status is returned in the SOAP response.

### UpdateService

Update the properties of a single Service.

The ServiceUrl cannot be updated. A fault will be returned.

Inverse list policy for this release: DisplayName updates are not propagated to the inverse list. This is because the inverse list may want to have a custom name for the entry that is different than the name assigned by the sharer.

The caller MUST be Passport authenticated and have access to the specified Namespace.

Method Signature

```
public void UpdateService(
  NamespaceHandle nsHandle,
  Service service
)
```

Parameters

Information specific to this method is listed here. The rest of the information on the fields can be found in the appropriate sections at the beginning of the document.

[hdr] Application Header

See the SOAP Header section for more information.

[in] nsHandle

.NamespaceID
Target namespace.

.PassportName
Not used. If sent, a fault will be returned: Bad Argument NamespaceHandle cannot contain both NamespaceId and PassportName values.

[in] service

Identifies the Service to update and the new properties.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

Info.Handle.ID
ID of the Service. Highly Recommended.

OR

.Info.Handle.Type
Cannot be updated.

.Info.Handle.ForeignID
Cannot be updated.

.Info.DisplayName
Optional. Friendly name for this Service.

.Info.InverseRequired
Cannot be updated.

.Info.Memberships
MUST be NULL. If not null, a BadArgument exception will be thrown.

.Changes
Set by the caller to indicate which fields should be updated. Required. See ServicePropertyType.

[return] void

Status is returned in the SOAP response.

Memberships

Memberships cannot be set through UpdateService. Use AddMember or SetMembership for this. If Memberships are passed as part of the Service, a BadArgument exception will be thrown.

### FindService

Find all Services registered to a Namespace.

The caller MUST be Passport authenticated and have access to the specified Namespace.

Method Signature

```
public Service[ ] FindService(
  NamespaceHandle namespaceHandle,
  ServiceFilter serviceFilter
)
```

Parameters

Information specific to this method is listed here. The rest of the information on the fields can be found in the appropriate sections at the beginning of the document.

[hdr] Application Header

See the SOAP Header section for more information.

[in] namespaceHandle

.NamespaceID
Target namespace.

.PassportName
Not used. If sent, a fault will be returned: Bad Argument NamespaceHandle cannot contain both NamespaceId and PassportName values.

[in] serviceFilter

If types and serviceHandles are all null, or the serviceFilter itself is null, all the Services in the Namespace will be returned.

.Types[ ]
To find Services by one or more types, include each type in the array.

OR

If the ID and the Type/ForeignID are both sent in the ServiceHandle, an exception will be returned.

.ServiceInfo.Handle.ID

ID of the Service. Highly Recommended.

OR

.serviceHandles[ ].Type
To find specific Services, include the type and foreign id of the target Service. NOTE: The type/ForeignID combination will be enforced to be unique!
Must be one of the ServiceType enumerations.

.serviceHandles[ ].ForeignID
The unique ID used by the Service Provider to identify the Service.
Use an empty string instead of null.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

[return] Service[ ]

Returns the properties of the Services found.

ServiceFilter

Only one of the serviceFilter.Types and serviceFilter.Handles can be specified. Maximum array size for both is 20.

### FindInverseService

Find all Services shared to a Namespace. This is not the list of Services owned by the Identity(s) represented by the Namespace, but rather the list of Services shared to the Namespace. This list is maintained independently of the Role Mappings in the system. FindInverseServiceResult does not contain the Roles of the Identity, only the Service information.

Note: There is a FindInverseService, AddInverseService, and DeleteInverseService, but there is no UpdateInverseService in the first release. UpdateInverseService would be useful for changing the friendly name of a service assigned to me.

The caller MUST be Passport authenticated and have access to the specified Namespace.

Method Signature

```
public FindInverseServiceResult FindInverseService(
  NamespaceHandle nsHandle,
  ServiceFilter serviceFilter
)
```

Parameters

Information specific to this method is listed here. The rest of the information on the fields can be found in the appropriate sections at the beginning of the document.

[hdr] Application Header

See the SOAP Header section for more information.

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceFilter

If types and serviceHandles are all null, or the serviceFilter itself is null, all the Services in the Inverse list will be returned.

Types[ ]
To find Services by one or more types, include each type in the array.

OR

ServiceHandles[ ].Type
Only one array element is allowed in this release. To find specific Services, include the type and foreign id of the target Service. NOTE: The type/ForeignID combination will be enforced to be unique!
Must be one of the ServiceType enumerations.

ServiceHandles[ ].ForeignID
Only one array element is allowed in this release. The unique ID used by the Service Provider to identify the Service.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

AND

.LastChange
Timestamp used for timestamp-based synchronization

[return] FindInverseServiceResult

Returns the properties of each Service found.

InverseRequired does not apply. Namespace, Name, URL, and ServiceHandle are supplied.

Any change to the inverse list will update the LastChange date in the result.

Return Value (FindInverseService Result)

| public class FindInverseServiceResult | |
|---|---|
| { | |
| public ServiceLocation[ ] | ServiceLocations; |
| public System.DateTime | LastChange; |
| } | |

Timestamp Synchronization

When FindInverseService is called with an up-to-date timestamp (ServiceFilter.LastChange), NULL will be returned. This indicates that no changes have occurred on the inverse list.

When FindInverseService is called and the inverse list is empty, a FindInverseServiceResult with a new timestamp will be returned.

Any change to the inverse list will update the LastChange date in the result. This LastChange date should be used in subsequent requests to FindInverseService.

If you specify LastChange date greater then the last accessed date for the inverse service, an InvalidSyncTimeStamp fault will be returned.

### AddInverseService

Adds a Service to the Namespace's Inverse list.

When a Service is added to the Namespace's inverse list, the corresponding Role Mapping's MemberState is updated with MemberState.Approved to indicate this Namespace is no longer Pending. See Add State Policy and EveryoneMember below for more information.

DisplayName and URL for the Inverse Service cannot be set with AddInverseService. These 2 properties will be copied from the Service in the corresponding Namespace.

Method Signature

```
public void AddInverseService(
  NamespaceHandle nsHandle,
  ServiceLocation[ ]  serviceLocations
)
```

Parameters

Information specific to this method is listed here. The rest of the information on the fields can be found in the appropriate sections at the beginning of the document.

[hdr] Application Header

See the SOAP Header section for more information.

[in] nsHandle

.NamespaceID
Target namespace.

.PassportName
Not used. If sent, a fault will be returned: Bad Argument NamespaceHandle cannot contain both NamespaceId and PassportName values.

[in] serviceLocations

.NamespaceHandle.ID
The Namespace where the Service is registered.

ServiceInfo.Handle.Type
The Service type.

ServiceInfo.Handle.ForeignID
The Service foreign id.

[return] void

Status is returned in the SOAP response.

Transaction Policy

This will be a 2 step synchronous operation that is not transacted. This will be rare, but if any of the steps fail, a fault will be sent back. This means that the following case IS POSSIBLE: An entry is added to the inverse list, but the Namespace is not updated with “Accepted”.

Add State Policy

For AddInverseService to be successful, the Identity must already exist in the Namespace with MemberState.Pending or MemberState.Accepted—or contain an entry for “Everyone.”

The InverseRequired property must be set on the service otherwise an error will be returned.

### DeleteInverseService

Removes Services from the Namespace's Inverse list.

The caller MUST be Passport authenticated and have access to the specified Namespace.

Method Signature

```
public void DeleteInverseService(
  NamespaceHandle namespaceHandle,
  ServiceLocation[ ]  serviceLocations
)
```

Parameters

Information specific to this method is listed here. The rest of the information on the fields can be found in the appropriate sections at the beginning of the document.

[hdr] Application Header

See the SOAP Header section for more information.

[in] namespaceHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceLocations

.NamespaceHandle.ID
The Namespace where the Service is registered.

.ServiceInfo.Handle.Type
The Service type.

.ServiceInfo.Handle.ForeignID
The Service foreign id.

[return] void

Status is returned in the SOAP response.

Inverse Synchronization Policy

When the Inverse entry is deleted, the associated Identity in the Service Rolemap is marked with the MemberState.Removed state. The Identity is NOT removed from the Service Rolemap. If the MemberState of the associated Identity cannot be updated, the call will still succeed.

### AddMember

Add one or more members to a role in a Service.
The caller MUST be Passport authenticated and have access to the specified Namespace.

Method Signature

```
public void AddMember(
  NamespaceHandle nsHandle,
  ServiceHandle serviceHandle,
  Membership[ ] Memberships,
  InviteOptions inviteOptions
)
```

Parameters

Information specific to this method is listed here. The rest of the information on the fields can be found in the appropriate sections at the beginning of the document.

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceHandle

The specific Service the Identity is contained within.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.ID
ID of the Service. Highly Recommended.

OR

.Type
Must be one of the ServiceType enumerations.

.ForeignID
The unique ID used by the Service Provider to identify the Service.
Use an empty string instead of null, since null directs the method to use the Handle.Id to identify the service.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

[in] Memberships

The membership to add.

.MemberRole

The RoleId of the Role. For example: CalFreeBusy

.Members

Members to add to the specific role

[in] inviteOptions

Specify what style of notification—invitation or announcement, the locale for the notification, etc.

If null, invitations are not sent.

See Invite Options section for more information.

[return] void

Status is returned in the SOAP response.

Add Logic

f you call AddMember in an attempt to add new Members into a role, and a membership already exists, it will not add a new Membership. It will add the new Members to the existing Membership associated with that role. If AddMember is called w/multiple memberships assigned to the same role, these memberships will be merged into the same membership associated w/the assigned role. The memberships passed into AddMember that are merged will not be retrievable individually after the AddMember call.

Sending Invitations

Invitations can be sent through AddMember by passing in inviteOptions. If left out, invitations will not be sent.

Invitations will only be sent to Members that have a MemberState of Pending.

PhoneIdentity

When an Identity of type PhoneIdentity is added via AddMember, any non-numeric digit will be stripped from the PhoneNumber property before insertion into system.

For example:

(425) 232-2322 becomes 4252322322

435-343-2122 becomes 4353432122

Dynamic Members

The MemberState for Identities of types Everyone, Group, or Role requires that it is set to Accepted instead of Pending.

Namespace Service Limitations

Users cannot perform an AddMember on the Namespace service, indicating that the added user has a “higher” role than the original user.

Membership ID

Membership IDs are NOT returned through AddMember. In order to retrieve the Membership IDs, execute a subsequent Find call.

### UpdateMember

Updates specific properties on one or more members in a Service.

The caller MUST be Passport authenticated and have access to the specified Namespace

Method Signature

```
public void UpdateMember(
  NamespaceHandle nsHandle,
  ServiceHandle serviceHandle,
  Membership[ ] Memberships
)
```

Parameters

Information specific to this method is listed here. The rest of the information on the fields can be found in the appropriate sections at the beginning of the document.

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceHandle

The specific Service the Identity is contained within.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.ID
ID of the Service. Highly Recommended.

OR

.Type
Must be one of the ServiceType enumerations.

.ForeignID
The unique ID used by the Service Provider to identify the Service.
Use an empty string instead of null, since null directs the method to use the Handle.Id to identify the service.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

[in] Memberships

The membership to update.

.MemberRole
The RoleId of the Role. For example: CalFreeBusy

.Members
Members to add to the specific role. MembershipId must be used to identify the member.

.Changes
Set by the caller to indicate which fields should be updated.
See MemberPropertyType

[return] void

Status is returned in the SOAP response.

Properties Changed

When modifying properties through UpdateMember, the Changes and/or IdentityChanges must be specified on the Member.

These properties are used to indicate which fields are being updated through UpdateMember.

### SetMembership

Set one or more members to a role in a Service. This means that any roles previously held by this Member are no longer valid.

The caller MUST be Passport authenticated and have access to the specified Namespace

Method Signature

```
public void SetMembership(
    NamespaceHandle nsHandle,
    ServiceHandle serviceHandle,
    Member[ ] members,
    RoleId[ ] roleIds
)
```

Parameters

Information specific to this method is listed here. The rest of the information on the fields can be found in the appropriate sections at the beginning of the document.

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceHandle

The specific Service the Identity is contained within.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.ID
ID of the Service. Highly Recommended.

OR

.Type
Must be one of the ServiceType enumerations.

.ForeignID
The unique ID used by the Service Provider to identify the Service.
Use an empty string instead of null, since null directs the method to use the Handle.Id to identify the service.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

[in] roleId[ ]
The roles to add the member to. Indicate the RoleId of the Roles.

[in] members
Members to add to the roles indicated above. MembershipId cannot be sent—a BadArgumentException will be thrown.

[in] inviteOptions

Specify what style of notification—invitation or announcement, the locale for the notification, etc.

If null, invitations are not sent.

See Invite Options section for more information.

[return] void

Status is returned in the SOAP response.

Sending Invitations

Invitations can be sent through SetMembership by passing in inviteOptions. If left out, invitations will not be sent.

Invitations will only be sent to Members that have a MemberState of Pending.

Membership IDs

Membership IDs will NOT be reused with SetMembership—all IDs will be reset as a result of the call. If Membership IDs are sent, a BadArgument fault will be returned.

Annotations

SetMembership WILL reset all annotations, since annotations are per membership. This means that partners MUST read annotations and rewrite annotations back to system when performing SetMembership if annotations are to persist across memberships.

Delta Sync

When SetMembership is called, and a subsequent Find call is executed, the Set operation will be represented as a DELETE and then an ADD. This is to ensure data integrity.

PhoneMember

When a member of type Phone is added via SetMembership, any non-numeric digit will be stripped from the PhoneNumber property before insertion into the system.

For example:

(425) 232-2322 becomes 4252322322

435-343-2122 becomes 4353432122

Dynamic Members

The MemberState for Identities of types Everyone, Group, or Role requires that it is set to Accepted instead of Pending.

Namespace Service Limitations

Users cannot perform a SetMembership on the Namespace service, indicating that the added user has a “higher” role than the original user.

### DeleteMember

Delete one or more Members from a single Service. This removes the Members from the given Roles.

If the requested Member does not exist, the delete fails.

The caller MUST be Passport authenticated and have access to the specified Namespace

Method Signature

```
public void DeleteMember(
    NamespaceHandle nsHandle,
    ServiceHandle serviceHandle,
    Membership[ ] memberships
)
```

Parameters

Information specific to this method is listed here. The rest of the information on the fields can be found in the appropriate sections at the beginning of the document.

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceHandle

The specific Service the Member is contained within.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.ID
ID of the Service. Highly Recommended.

OR

.Type
Must be one of the ServiceType enumerations.

.ForeignID
The unique ID used by the Service Provider to identify the Service.
Use an empty string instead of null, since null directs the method to use the Handle.Id to identify the service.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

[in] memberships

The member to delete.

.MemberRole
The RoleId of the Role for this Member.

[return] void

Status is returned in the SOAP response.

FindMembership

Returns a list of services matching the given service filter with their included role maps. If the serviceFilter is null then the method returns all services.

If there are no Identities assigned to a Service, the Service information will still be returned.

The caller MUST be Passport authenticated and have access to the specified Namespace.

MembershipView

Use MembershipView to limit the result set to just the properties you are interested in receiving.

| public class MembershipView | |
|---|---|
| { | |
| Full = 0, | // All Properties |
| Minimal | // Only the minimum necessary properties to define |
| | the rolemap (no Annotations, URL's etc.) |
| } | |

Definitions:

| Full | Minimal |
|---|---|
| All Service Properties | Service Properties |
| All Member Properties | ServiceHandle.Id |
| | ServiceHandle.Type |
| | ServiceHandle.ForeignId |
| | ServiceInfo.Annotations |
| | ServiceInfo.DisplayName |
| | ServiceInfo.Url |
| | Member Properties |
| | Member.MembershipId |
| | Member.Type |
| | Member.Location |
| | PhoneMember.PhoneNumber |
| | PassportMember.PassportId |
| | PassportMember.PassportName |
| | EmailMember.EmailAddress |
| | GroupMember.Id |
| | GuidMember.Id |
| | RoleMember.Id |
| | RoleMember.DefiningService |
| | Member.State |

In addition to these fields, the system will always return all boolean, int and datetime fields (all NET value types) irrespective of the view.

Method Signature

```
public MembershipResult FindMembership(
    NamespaceHandle nsHandle,
    ServiceFilter serviceFilter,
    MembershipView view,
    bool deltasOnly,
    DateTime lastChange
)
```

Parameters

Information specific to this method is listed here. The rest of the information on the fields can be found in the appropriate sections at the beginning of the document.

[in] namespaceHandle

Note: The Partner FE (IP filtered) will not have cookies, and therefore the nsId is required.

.NamespaceID
Target namespace.
If using the Public FE (Passport authed), and adding a Service to a Namespace associated to my PUID, pass null as the Namespace Id. This will cause the system to look at the Passport Cookies to determine the PUID to use to lookup the Namespace.
If using the Private FE (IP filtered), and adding a Service to a Namespace associated to my PUID, pass the zero extended PUID as the Namespace Id.

.PassportName
Not used. If sent, a fault will be returned: Bad Argument NamespaceHandle cannot contain both NamespaceId and PassportName values.

[in] serviceFilter

If the serviceFilter itself is null, all the rolemaps in all Services will be returned. if the ServiceFilter is not null, then we require not null ServiceFilter.Handles.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.Types[ ]

To find Services by one or more types, include each type in the array.

OR

.ID
ID of the Service. Highly Recommended.

OR

.ServiceHandles[ ].Type
Only one array element is allowed in this release. To find specific Services, include the type and foreign id of the target Service. NOTE: The type/ForeignID combination will be enforced to be unique!
Must be one of the ServiceType enumerations.

.ServiceHandles[ ].ForeignID
Only one array element is allowed in this release. The unique ID used by the Service Provider to identify the Service.

May be empty string if the Service Provider uses the PUID to identify the Service, and this Namespace is a PUID owned Namespace. Service Providers MUST NOT store the PUID in this field, as this field is passed in the clear during the SOAP requests.

view

MembershipView indicating which properties to return

deltasOnly

If set to true, only changed rolemaps will be returned

lastChange

If deltaOnly==true, lastChange should be set to the last known timestamp returned from FindMembership.

[return] MembershipResult

Services[ ]
Collection of Services with associated Rolemaps

C#—Return Value (MembershipResult)

public class MembershipResult
{
public Service[ ] Services
}

### FindMembershipByRole

Returns a list of services matching the given service filter with their included role memberships (i.e. the complete rolemap).

The rolemap is limited to the subset of given role IDs.

If the serviceFilter is null then the method returns all services.

If the includedRoleIds are null then the method returns the complete rolemaps.

The caller MUST be Passport authenticated and have access to the specified Namespace.

MembershipView

Use MembershipView to limit the result set to just the properties you are interested in receiving.

| public class MembershipView | |
|---|---|
| { | |
| Full = 0, | // All Properties |
| Minimal | // Only the minimum necessary properties to define |
| | the rolemap (no Annotations, URL's etc.) |
| } | |

Definitions:

| Full | Minimal |
|---|---|
| All Service Properties | Service Properties |
| All Member Properties | ServiceHandle.Id |
| | ServiceHandle.Type |
| | ServiceHandle.ForeignId |
| | ServiceInfo.Annotations |
| | ServiceInfo.DisplayName |
| | ServiceInfo.Url |
| | Member Properties |
| | Member.MembershipId |
| | Member.Type |
| | Member.Location |
| | PhoneMember.PhoneNumber |
| | PassportMember.PassportId |
| | PassportMember.PassportName |
| | EmailMember.EmailAddress |
| | GroupMember.Id |
| | GuidMember.Id |
| | RoleMember.Id |
| | RoleMember.DefiningService |
| | Member.State |

In addition to these fields, the system will always return all boolean, int and datetime fields (all .NET value types) irrespective of the view. The cost to return these is minor since these always get sent back by the NET Framework.

Method Signature

```
public MembershipResult FindMembershipByRole(
    NamespaceHandle nsHandle,
    ServiceFilter serviceFilter,
    RoleId[ ] includedRoles,
    MembershipView view
)
```

Parameters

Information specific to this method is listed here. The rest of the information on the fields can be found in the appropriate sections at the beginning of the document.

[in] namespaceHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceFilter

If the serviceFilter itself is null, all the rolemaps in all Services will be returned. if the ServiceFilter is not null, then we require not null ServiceFilter.Handles.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.Types[ ]
To find Services by one or more types, include each type in the array.

OR

.ID
ID of the Service. Highly Recommended.

OR

.ServiceHandles[ ].Type
Only one array element is allowed in this release. To find specific Services, include the type and foreign id of the target Service. NOTE: The type/ForeignID combination will be enforced to be unique!
Must be one of the ServiceType enumerations.

.ServiceHandles[ ].ForeignID
Only one array element is allowed in this release. The unique ID used by the Service Provider to identify the Service.
May be empty string if the Service Provider uses the PUID to identify the Service, and this Namespace is a PUID owned Namespace. Service Providers MUST NOT store the PUID in this field, as this field is passed in the clear during the SOAP requests.

includedRoleIds

Roles in which to return Members

view

MembershipView indicating which properties to return

[return] MembershipResult

Services[ ]
Collection of Services with associated Rolemaps

C#—Return Value (MembershipResult)

public class MembershipResult
{
public Service[ ] Services
}

### FindMembershipByMember

Returns a collection of services matching the given service filter with the included Memberships for that role member.

If the serviceFilter is null then the method returns all services. The caller MUST be Passport authenticated and have access to the specified Namespace.

MembershipView

Use MembershipView to limit the result set to just the properties you are interested in receiving.

| public class MembershipView | |
|---|---|
| { | |
| Full = 0, | // All Properties |
| Minimal | // Only the minimum necessary properties to define |
| | the rolemap (no Annotations, URL's etc.) |
| } | |

Definitions:

| Full | Minimal |
|---|---|
| All Service Properties | Service Properties |
| All Member Properties | ServiceHandle.Id |
| | ServiceHandle.Type |
| | ServiceHandle.ForeignId |
| | ServiceInfo.Annotations |
| | ServiceInfo.DisplayName |
| | ServiceInfo.Url |
| | Member Properties |
| | Member.MembershipId |
| | Member.Type |
| | Member.Location |
| | PhoneMember.PhoneNumber |
| | PassportMember.PassportId |
| | PassportMember.PassportName |
| | EmailMember.EmailAddress |
| | GroupMember.Id |
| | GuidMember.Id |
| | RoleMember.Id |
| | RoleMember.DefiningService |
| | Member.State |

In addition to these fields, the system will always return all boolean, int and datetime fields (all .NET value types) irrespective of the view. The cost to return these is minor since these always get sent back by the .NET Framework.

Method Signature

```
public MembershipResult FindMembershipByMember(
    NamespaceHandle nsHandle,
    ServiceFilter serviceFilter,
    Member member,
    MembershipView view
)
```

Parameters

[in] namespaceHandle

Note: The Partner FE (IP filtered) will not have cookies, and therefore the nsId is required.

.NamespaceID
Target namespace.

.PassportName
Not used. If sent, a fault will be returned: Bad, Argument NamespaceHandle cannot contain both NamespaceId and PassportName values.

[in] serviceFilter

If the serviceFilter itself is null, all the rolemaps in all Services will be returned. if the ServiceFilter is not null, then we require not null ServiceFilter.Handles.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

Types[ ]
To find Services by one or more types, include each type in the array.

OR

.ID
ID of the Service. Highly Recommended.

OR

.ServiceHandles[ ].Type
Only one array element is allowed in this release. To find specific Services, include the type and foreign id of the target Service. NOTE: The type/ForeignID combination will be enforced to be unique!
Must be one of the ServiceType enumerations.

.ServiceHandles[ ].ForeignID
Only one array element is allowed in this release. The unique ID used by the Service Provider to identify the Service.
May be empty string if the Service Provider uses the PUID to identify the Service, and this Namespace is a PUID owned Namespace. Service Providers MUST NOT store the PUID in this field, as this field is passed in the clear during the SOAP requests.

[in] member

The member searched for.

.Id

The Id of the Member over the Private FE. Over the Public FE, only PassportMembers are supported via PassportName.

view

MembershipView indicating which properties to return

[return] MembershipResult

Services[ ]
Collection of Services with associated Rolemaps

C#—Return Value (MembershipResult)

public class MembershipResult
{
public Service[ ] Services
}

MemberHasRole

Determines whether a Member has one of the given roles in the given service.

Returns true if the Member has at least one of the roles for the service, either directly or indirectly through membership in a group or role that is targeted by one of the given roles.

The Member must be Pending or Accepted in the Namespace for MemberHasRole to return true.

Method Signature

```
public bool MemberHasRole(
    NamespaceHandle nsHandle,
    ServiceHandle serviceHandle,
    Member member,
    RoleId[ ] roles)
```

Parameters

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceHandle

The specific Service the Member is contained within.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.ID
ID of the Service. Highly Recommended.

OR

.Type
Must be one of the ServiceType enumerations.

.ForeignID
The unique ID used by the Service Provider to identify the Service.
Use an empty string instead of null, since null directs the method to use the Handle.Id to identify the service.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

[in] Member

If PassportMember:

.MemberName
Provide the Passport member name here.

.Puid
Provide Passport PUID here. If called on the private FE Puid is used.

If EmailMember:

.EmailAddress
EmailAddress of Member here.

If PhoneMember:

.PhoneNumber
PhoneNumber of Member here.

If GuidMember:

.Guid
Guid of Member here.

If EveryoneMember:

No addition parameter required.

If GroupMember:

.Guid
Guid of Member here.

If ServiceMember:

.PhoneNumber
DefiningService of Member here.

[in] RoleId

The roleIds to search for.

[return] bool

True means Identity has role; False means Identity does not have role.

### SendInvitation

This method allows the caller of the Service to send an invitation to Members. SendInvitation will reset the MemberState to Pending.

The caller MUST be Passport authenticated and have access to the specified Namespace.

Method Signature

```
public void SendInvitation(
    NamespaceHandle nsHandle,
    ServiceHandle serviceHandle,
    InviteOptions inviteOptions,
    Member[ ] members
)
```

Parameters

Information specific to this method is listed here. The rest of the information on the fields can be found in the appropriate sections at the beginning of the document.

[hdr] Application Header

See the SOAP Header section for more information.

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceHandle

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.ID

ID of the Service. Highly Recommended.

OR

The type and foreign ID of the target Service.

.Type
ServiceType

.ForeignID
Foreign ID maintained by the Service Provider.

[in] inviteOptions

Specify what style of notification—invitation or announcement, the locale for the notification, etc.

See Invite Options section for more information.

[in] members

Members to add to the specific role

[return] void

Status is returned in the SOAP response.

### AcceptInvitation

Adds a Service to the Member's Inverse list and sets the MemberState to Accepted in the originating Namespace.

Also removes the entry from the recipient's Pending list (Messenger Service, Pending Role) if it exists.

Method Signature

```
public void AcceptInvitation(
    NamespaceHandle nsHandle,
    ServiceLocation[ ] serviceLocations
)
```

Parameters

Information specific to this method is listed here. The rest of the information on the fields can be found in the appropriate sections at the beginning of the document.

[hdr] Application Header

See the SOAP Header section for more information.

[in] nsHandle

Note: The Partner FE (IP filtered) will not have cookies, and therefore the nsId is required.

.NamespaceID
Target namespace.
f using the Public FE (Passport authed), and adding a Service to a Namespace associated to my PUID, pass null as the Namespace Id. This will cause the system to look at the Passport Cookies to determine the PUID to use to lookup the Namespace.
If using the Private FE (IP filtered), and adding a Service to a Namespace associated to my PUID, pass the zero extended PUID as the Namespace Id.

.PassportName

Not used. If sent, a fault will be returned: Bad Argument NamespaceHandle cannot contain both NamespaceId and PassportName values.

[in] serviceLocations

.NamespaceHandle.ID
The Namespace where the Service is registered.

If the ID and the Type/ForeignID are both sent in the ServiceHandle, an exception will be returned.

.ServiceInfo.Handle.ID
ID of the Service. Highly Recommended.

OR

.ServiceInfo.Handle.Type
The Service type.

.ServiceInfo.Handle.ForeignID
The Service foreign id.

[return] void

Status is returned in the SOAP response.

Add State Policy

For AcceptInvitation to be successful, the Identity must already exist in the Namespace with MemberState.Pending or MemberState.Accepted—or contain a dynamic entry in which the member resolves to (i.e. Everyone or Allow role).

The InverseRequired property does not need to be set on the service. In the case that it is not set, an inverse list entry will not be added.

Role Resolution

AcceptInvitation will succeed if the caller is a member of the Namespace indirectly through a role, Address Book group, or “Everyone”. In this case, an entry will be added to the Inverse List, but the MemberState in the original Namespace will not be modified.

If the Service currently has an entry for to Everyone AND the Member specified, AcceptInvitation will set the MemberState to Accepted on the Member—not Everyone—if the Member already exists within the Namespace with MemberState.Pending or MemberState.Accepted.

### DeclineInvitation

Sets a user's MemberState to Declined in the originating Namespace.

Also removes the entry from the recipient's Pending list (Messenger Service, Pending Role) if it exists.

Method Signature

```
public void DeclineInvitation(
    NamespaceHandle nsHandle,
    ServiceLocation[ ] serviceLocations
)
```

Parameters

Information specific to this method is listed here. The rest of the information on the fields can be found in the appropriate sections at the beginning of the document.

[hdr] Application Header

See the SOAP Header section for more information.

[in] namespaceHandle

Note: The Partner FE (IP filtered) will not have cookies, and therefore the nsId is required.

.NamespaceID
Target namespace.
If using the Public FE (Passport authed), and adding a Service to a Namespace associated to my PUID, pass null as the Namespace Id. This will cause the system to look at the Passport Cookies to determine the PUID to use to lookup the Namespace.
If using the Private FE (IP filtered), and adding a Service to a Namespace associated to my PUID, pass the zero extended PUID as the Namespace Id.

.PassportName
Not used. If sent, a fault will be returned: Bad Argument NamespaceHandle cannot contain both NamespaceId and PassportName values.

[in] serviceLocations

.NamespaceHandle.ID
The Namespace where the Service is registered.

If the ID and the Type/ForeignID are both sent in the ServiceHandle, an exception will be returned. To indicate that the Type/ForeignId is being used the ID should be set to 0. To indicate that the ID is to be used the ForeignID should be set to Null.

.ServiceInfo.Handle.ID
ID of the Service. Highly Recommended.

OR

.ServiceInfo.Handle.Type
The Service type.

.ServiceInfo.Handle.ForeignID
The Service foreign id.

[return] void

Status is returned in the SOAP response.

Decline State Policy

For DeclineInvitation to be successful, the Member must already exist in the Namespace with MemberState.Pending, MemberState.Declined, or MemberState.Accepted or be a member of another dynamic entry (i.e. Everyone).

Role Resolution

DeclineInvitation will succeed if the caller is a member of the Namespace indirectly through a role, Address Book group, or “Everyone”. In this case, the MemberState in the original Namespace will not be modified.

### AddPrincipal

Add one or more Principals to a Service.

The caller MUST be Passport authenticated and have access to the specified Namespace.

Only Members of type Passport can be added via AddPrincipal. Other MemberTypes are not supported in legacy method signatures, so no fault is required.

AddPrincipalOptions

| public class AddPrincipalOptions | |
|---|---|
| { | |
| bool | SendInvitation; |
| InviteOptions | CustomInviteOptions; |
| IdentityState | InitialIdentityState; |
| } | |

AddPrincipal

```
[SoapHeader(“m_abAppHeader”, Required=true)]
public void AddPrincipal(
    NamespaceHandle nsHandle,
    ServiceHandle serviceHandle,
    AddPrincipalOptions addOptions,
    Principal[ ] principals
)
```

Parameters

[hdr] Application Header

See the SOAP Header section for more information.

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceFilter

The type and foreign id of the target Service. Only one Service may be specified.

[in] addOptions

Specify the whether a notification should be sent. If sending an notification, what style of notification—invitation or announcement, the locale for the notification, etc.

.SendInvitation
If true, an invitation will be sent to this user.

.CustomInviteOptions
Customization options for the invite itself. See the section on Invite Options for more information.

[in] principals[ ]

The Identitiy and associated Roles to add to the Service. In the first release, only one principal may be added.

.IdentityInfo
The Identity being added.

.RoleIds[ ]
The Roles for that Identity

[return] void

Status is returned in the SOAP response.

IdentityType.Everyone

The IdentityState for Identities of type Everyone requires that AddPrincipalOptions.InitialIdentityState is set to Accepted instead of Pending.

DisplayName

A displayName cannot be passed to AddPrincipal. An error will be returned—“BadArgument Principal.IdentityInfo.DisplayName has to be null”

### DeletePrincipal

Delete one or more Principals from a single Service. This removes the Roles from the given Identities. Can also be used to delete an Identity from all Roles in the Service.

If the requested Identity does not exist, the delete fails.

Only Members of type Passport (v10) can be deleted via DeletePrincipal. Other MemberTypes are not supported in legacy method signatures, so no fault is required.

The caller MUST be Passport authenticated and have access to the specified Namespace.

DeletePrincipal

```
[SoapHeader(“m_abAppHeader”, Required=true)]
public void DeletePrincipal(
    NamespaceHandle nsHandle,
    ServiceHandle serviceHandle,
    Principal[ ] principals
)
```

Parameters

[hdr] Application Header

See the SOAP Header section for more information.

[in] nsHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceHandle

The type and foreign id of the target Service.

[in] principals[ ]

The Identities and associated Roles to delete from the Service.

Only one principal allowed per call in this release.

.IdentityInfo
The Identity being deleted.

RoleIds[ ]
The Roles for that Identity
If the roleIds are null, the Identity will be deleted from all the Roles in the Service.

[return] void

Status is returned in the SOAP response.

Rolemap/Inverse Synchronization Policy

After the specified Roles are removed from the Identity, if the Identity no longer has a Role in the Service, the Inverse entry for the Service will be marked with the IdentityStateRemoved state. The inverse entry is NOT removed from the Inverse list.

### FindPrincipal

This method call has one primary purpose: enumerating the Rolemap.

If there are no Identities assigned to a Service, the Service information will be still be returned. The Principal will be null in that case.

The caller MUST be Passport authenticated and have access to the specified Namespace.

PrincipalFilter

Provide the ability to query for identities in one or more Roles. Gives the ability to request the Allow and Block list identities, without having to retrieve the reverse list.

[in] principalFilter

.RoleIds
If the principalFilter.RoleIds is set, only the Indentities in those Roles are returned. Multiple RoleIds are allowed. If PrincipalFilter is supplied, then we require not null PrincipaFilter.RoleIds

FindPrincipal

```
[SoapHeader(“m_abAppHeader”, Required=true)]
public Rolemap[ ] FindPrincipal(
    NamespaceHandle namespaceHandle,
    ServiceFilter serviceFilter,
    PrincipalFilter principalFilter
)
```

Parameters

[hdr] Application Header

See the SOAP Header section for more information.

[in] namespaceHandle

Note: The Partner FE (IP filtered) will not have cookies, and therefore the nsId is required.

.NamespaceID
Target namespace.

.PassportName
Not used. If sent, a fault will be returned: Bad Argument NamespaceHandle cannot contain both NamespaceId and PassportName values.

[in] serviceFilter

If the serviceFilter itself is null, all the Principals in all Services will be returned. if the ServiceFilter is not null, then we require not null ServiceFilter.Handles. You MUST be the owner of the Namespace in this case.

.ServiceTypes[ ]
Must be NULL in this release. To find Services by one or more types, include each type in the array.

OR

.ServiceHandles[ ].Type
Only one array element is allowed in this release. To find specific Services, include the type and foreign id of the target Service. NOTE: The type/ForeignID combination will be enforced to be unique!
Must be one of the ServiceType enumerations.

.ServiceHandles[ ].ForeignID
Only one array element is allowed in this release. The unique ID used by the Service Provider to identify the Service.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

[in] principalFilter

May also filter only for a given Role.

.RoleIds
If the principalFilter.RoleIds is set, only the Indentities in those Roles are returned.
if PrincipalFilter is supplied, then we require not null PrincipaFilter.RoleIds
Multiple RoleIds are allowed in R9.

[return] Rolemap[ ]

The set of Service/Principal collections for a single Identity within a Namespace.

Enumerating the Rolemap

You must be an owner of the Namespace to enumerate the Rolemap. See the section on Passport Authentication for information on Namespace ownership.

Only one of the serviceFilter.Types and serviceFilter.Handles can be specified.

ServiceFilter indicates which service instances to be included in the result. If ServiceFilter is supplied, then we require not null ServiceFilter.Handles.

PrincipalFilter indicates for each of the service instances to be returned, which principal will be returned—only the principal with roles specified in the input PrincipalFilter will be returned.

If PrincipalFilter is null, all services and all principals within these services will be returned.

If PrincipalFilter.RoleIds is null, all principals within the service instances specified by the ServiceFilter will be returned.

If the principalFilter.RoleIds is set, only the Identities in those Roles are returned.

PrincipalFilter.RoleIds cannot be empty if the PrincipalFilter is defined; a BadArgument error will be returned.

Setting ServiceFilter=null and PrincipalFilter=null returns all principals and services, as expected. If ServiceFilter is not null, then ServiceFilter.Handles must not be null.

LastChange

FindPrincipal will return an error if ServiceFilter.LastChange is specified in this release.

ErrorCode: NotSupported

ErrorString: The specified interface or parameter type is not supported in this release.ServiceFilter.LastChange is not supported

DisplayName

FindPrincipal returns PassportName in DisplayName field if the DisplayName is empty.

LastAccessedDate

The LastAccessedDate on the Namespace is only updated when the owner of the Namespace accesses the Namespace. If another user accesses your Namespace to check their Role, the lastAccessed is not updated.

Returns Rolemap

```
  public class Rolemap
  {
      public Service Service;
    public Principal[ ] Principals;
}
```

### FindIdentityRoles

This method call has one primary purpose:
Determining access. Find the Roles of a single Identity for a single Service that I do not own.

FindIdentityRoles returns Null if there are no roles for this Identity in this Service (including “Everyone”—see section below on IdentityType.Everyone).

This call does NOT affect the last accessed date on the Namespace. This prevents someone from sharing out their resources to numerous people, and having the resources never expire, because they are constantly accessed by other people.

The caller MUST be Passport authenticated and have access to the specified Namespace.

FindIdentityRoles

```
[SoapHeader(“m_abAppHeader”, Required=true)]
public Principal[ ] FindIdentityRoles(
  NamespaceHandle nsHandle,
  ServiceHandle serviceHandle,
  IdentityHandle identityHandle
)
```

Parameters

[hdr] Application Header

See the SOAP Header section for more information.

[in] nsHandle

.NamespaceID
Target namespace.

.PassportName
Used for Passport lookup—Namespace ID is based on what is sent with PassportName.

[in] serviceHandle

The specific Service the Identity is contained within.

.Type
Must be one of the ServiceType enumerations.

.ForeignID
The unique ID used by the Service Provider to identify the Service.
Use an empty string instead of null.
May be empty string if the Service Provider uses the PUID to identify the Service, and this Namespace is a PUID owned Namespace (fDefault=true). Service Providers MUST NOT store the PUID in this field, as this field is passed in the clear during the SOAP requests.

[in] identityHandle
If null, the Identity will be taken from the Passport cookies of the caller. The IP Filtered Front End has no Passport cookies in the call, therefore identityHandle will be required.

.Type
Must be one of the IdentityType enumerations.

.Name
If IdentityType is IdentityTypePassport, provide the Passport member name here.

.Puid
If IdentityType is IdentityTypePuid, provide the Passport PUID here. Returned principal will always have Name set to null.

[return] Principal

The IdentityInfo and RoleIds are returned for this identity's access to the service.

Determining Access

You MUST be the Passport authenticated as identityHandle. You may NOT ask for another person's identity on an arbitrary Rolemap.

If the principalFilter.identityHandles must be set to the callers Identity.

If the principalFilter.identityHandles is null, and the caller is not the owner of the Service, an error will be returned.

IdentityType.Everyone

If IdentityType.Everyone is defined in the service's rolemap, we will return TWO principals; one for Everyone and one for the identityHandle.

It is up to the consumer of the method to determine which takes precedence.

DisplayName

FindIdentityRoles returns PassportName in DisplayName field if the DisplayName is empty.

### InviteIdentity

Used to resend invitations to Identities about the Service shared to them.

This method allows the owner of the Service to send an invitation to another user. This method does not allow a user to request access to a Service.

InviteIdentity will reset the IdentityState to Pending.

The caller MUST be Passport authenticated and have access to the specified Namespace.

InviteIdentity

```
[SoapHeader(“m_abAppHeader”, Required=true)]
public void InviteIdentity(
  NamespaceHandle nsHandle,
  ServiceHandle serviceHandle,
  InviteOptions inviteOptions,
  IdentityHandle[ ] identityHandles
)
```

Parameters

[hdr] Application Header

See the SOAP Header section for more information.

[in] nsHandle

Note: The Partner FE (IP filtered) will not have cookies, and therefore the nsId is required.

.NamespaceID
Target namespace.
If using the Public FE (Passport authed), and adding a Service to a Namespace associated to my PUID, pass null as the Namespace Id. This will cause the ABCH to look at the Passport Cookies to determine the PUID to use to lookup the Namespace.

If using the Private FE (IP filtered), and adding a Service to a Namespace associated to my PUID, pass the zero extended PUID as the Namespace Id.

.PassportName
Not used. If sent, a fault will be returned: Bad Argument NamespaceHandle cannot contain both NamespaceId and PassportName values.

[in] serviceHandle

The type and foreign id of the target Service.

.Type
ServiceType

.ForeignID
Foreign ID maintained by the Service Provider.

[in] inviteOptions

Specify what style of notification—invitation or announcement, the locale for the notification, etc.

See Invite Options section for more information.

[in] identityHandles[ ]

The Identities the invitations should be sent to.

.Type
IdentityType

.Puid
Puid of the Identity

[return] void

Status is returned in the SOAP response.

1. A method, comprising:
processing a received service selection; and
identifying a role and an entity associated with the service selection.

2. The method according to claim 1, wherein the received service selection is identified by a user having association and access to the service selection.

3. The method according to claim 2, wherein the service selection is a calendar, and wherein a user having association and access to the calendar controls at least additions and deletions of information storable in conjunction with the calendar.

4. The method according to claim 1, wherein the role defines a level of access the entity has to the service selection.

5. The method according to claim 4, wherein the service selection is a calendar.

6. The method according to claim 1, wherein the received service selection originates from an authorized user having undergone an authorization process.

7. The method according to claim 6, wherein the authorization process uses the Microsoft® .NET Passport.

8. The method according to claim 6, wherein the entity undergoes the authorization process that the authorized user undergoes.

9. The method according to claim 8, wherein the authorization process uses the Microsoft® .NET Passport.

10. The method according to claim 1, further comprising communicating to the entity that the entity has an association with the service selection.

11. The method according to claim 1, further comprising receiving an indication the entity accepted the service selection.

12. The method according to claim 10, wherein communicating to the entity that the entity has an association with the service selection is accomplished by way of one of email, instant messaging, text messaging and phone.

13. The method according to claim 1, further comprising allocating a storage space for storing the received service selection.

14. The method according to claim 1, further comprising receiving a query from an entity requesting whether any users have granted the entity access to at least one service selection.

15. The method according to claim 14, further comprising communicating to the entity information pertaining to the query.

16. The method according to claim 1, further comprising receiving a query from an entity requesting whether the entity has a role associated with at least one service.

17. The method according to claim 16, comprising communicating to the entity information pertaining to the query.

18. The method according to claim 1, further comprising processing a request from a user for information pertaining to any services and roles assigned to one or more entities associated with the user.

19. The method according to claim 2, wherein the user is a group of individual users.

20. The method according to claim 1, wherein identifying a role associated with the received service selection includes identifying at least a plurality of roles associated with the received service selection.

21. The method according to claim 12, wherein the service selection is a calendar, and wherein a user having association and access to the calendar controls at least additions and deletions of information storable in conjunction with the calendar.

22. The method according to claim 13, wherein the plurality of roles define that the user may control certain operational aspects associated with the calendar.

23. A programming interface layer embodying the method of any of claims 1-22.

24. A computer readable media containing computer executable instructions for performing the method of any of claims 1-22.

25. A computer system having a processor and a memory storing computer executable instructions operative to perform the method of any of claims 1-22.
